(19) United States
(12) Patent Application Publication
(10) Pub. No.: US 2025/0167599 A1
(43) Pub. Date: May 22, 2025

(54) CHARGING DEVICE

(71) Applicant: Panasonic Automotive Systems Co., Ltd., Kanagawa (JP)

(72) Inventors: Hajime HOMMA, KANAGAWA KEN (JP); Eiichi KURAISHI, KANAGAWA KEN (JP); Daishi IWAMOTO, KANAGAWA KEN (JP); Atuhiko HASIGAYA, KANAGAWA KEN (JP); Toshihiro OKUDA, TOKYO TO (JP); Toshiaki SEKI, KANAGAWA KEN (JP)

(73) Assignee: Panasonic Automotive Systems Co., Ltd., Kanagawa (JP)

(21) Appl. No.: 18/936,268

(22) Filed: Nov. 4, 2024

(30) Foreign Application Priority Data
Nov. 17, 2023 (JP) 2023-195984

(51) Int. Cl. H02J 50/60; H02J 50/00; H02J 50/10; H02J 50/90

(52) U.S. Cl. CPC H02J 50/60; H02J 50/005; H02J 50/10; H02J 50/90

(57) ABSTRACT

A charging device includes: a power transmission coil configured to transmit electric power to a terminal device; a position detection coil that includes a plurality of coils, and is configured to detect a position of a power reception coil of the terminal device; a foreign substance detection coil that includes a plurality of coils corresponding to the plurality of coils of the position detection coil; and a processor configured to supply electric power to a first coil among the plurality of coils of the foreign substance detection coil in a state in which the terminal device is not placed on a placement part, to determine that a conductive foreign substance is present on the placement part in a case in which a variation amount of induced voltage generated in the position detection coil is equal to or larger than a predetermined threshold.

### CROSS-REFERENCE TO RELATED APPLICATIONS

This application is based upon and claims the benefit of priority from Japanese Patent Application No. 2023-195984, filed Nov. 17, 2023, the entire contents of which are incorporated herein by reference.

### FIELD

The present disclosure relates to a charging device.

### BACKGROUND

In the related art, there is known a charging device that moves a power transmission coil to a position of a power reception coil of a terminal device (charging target) with a built-in battery, and performs wireless charging (contactless charging) for the charging target by the power transmission coil. In such a charging device, there is a problem in that, if a conductive foreign substance such as a coin is present on a placement surface on which the charging target is placed, the conductive foreign substance generates heat when receiving transmitted power from the charging device. On the other hand, regarding an echo signal from the charging target corresponding to a pulse emitted from the charging device, there is known a technique of detecting a conductive foreign substance on a placement surface using the fact that a frequency characteristic such as a Q value (Quality Factor) varies due to presence of the conductive foreign substance (for example, refer to Japanese Patent No. 6706751).

However, in a case in which the charging target is not placed on the placement surface, it is difficult to detect a foreign substance because there is no echo signal from a resonance circuit of the charging target. Additionally, even in a case in which the charging target is placed thereon, there is a problem in that it takes time to detect the conductive foreign substance based on the echo signal from the charging target. Furthermore, from a viewpoint of safety, there is a problem in that it takes time until transmitted power becomes maximum even in a case in which there is no conductive foreign substance such that the transmitted power is suppressed until it is determined that “there is no foreign substance”.

The present disclosure has an object to detect the conductive foreign substance on the placement surface before the charging target of wireless charging is placed on the placement surface.

### SUMMARY

A charging device according to the present disclosure is configured to perform wireless charging for a terminal device that is placed on a placement part and includes a power reception coil for receiving wirelessly transmitted electric power. The charging device includes a power transmission coil for charging, a position detection coil, a foreign substance detection coil, a memory, and a processor. The power transmission coil for charging is configured to transmit electric power to the terminal device. The position detection coil includes a plurality of coils, and is configured to detect a position of the power reception coil of the terminal device. The foreign substance detection coil includes a plurality of coils corresponding to the plurality of coils of the position detection coil, and is configured to detect a conductive foreign substance on the placement part. The processor is coupled to the memory and configured to supply electric power to a first coil among the plurality of coils of the foreign substance detection coil in a state in which the terminal device is not placed on the placement part, to determine that the conductive foreign substance is present on the placement part in a case in which a variation amount of induced voltage generated in the position detection coil in accordance with a magnetic field generated from the first coil is equal to or larger than a predetermined threshold.

### BRIEF DESCRIPTION OF THE DRAWINGS

FIG. 1 is a perspective view illustrating an example of a state in which a charging device according to the present disclosure is disposed in an automobile;

FIG. 2 is a perspective view illustrating an example of a configuration of the charging device in FIG. 1;

FIG. 3 is a perspective view illustrating an example of a state in which a terminal device is disposed on the charging device in FIG. 2;

FIG. 4 is a perspective view illustrating a state in which part of the charging device in FIG. 2 is removed;

FIG. 5 is a plan view illustrating the charging device in the state of FIG. 4;

FIG. 6 is a side cross-sectional view illustrating a cross section along a dashed line S-S′ of the charging device in FIG. 2;

FIG. 7 is a perspective view illustrating another state of the charging device in FIG. 4;

FIG. 8 is a plan view illustrating the charging device in the state of FIG. 7;

FIG. 9 is a control block diagram illustrating an example of a configuration of a charging device according to a first embodiment;

FIG. 10 is a control block diagram illustrating an example of a configuration of a position detection unit in FIG. 9;

FIG. 11 is a control block diagram illustrating an example of a configuration of a foreign substance detection unit in FIG. 9;

FIG. 12 is a diagram schematically illustrating an example of the configuration of the foreign substance detection unit in FIG. 9;

FIG. 13 is a diagram illustrating an example of a cross section along a dashed line A-A′ of the foreign substance detection unit in FIG. 12;

FIG. 14 is a diagram illustrating another example of the cross section along the dashed line A-A′ of the foreign substance detection unit in FIG. 12;

FIG. 15 is a diagram illustrating another example of the cross section along the dashed line A-A′ of the foreign substance detection unit in FIG. 12;

FIG. 16 is a waveform diagram illustrating an example of an application pulse and a detection pulse emitted by the foreign substance detection unit in FIG. 9;

FIG. 17 is a diagram schematically illustrating another example of a configuration of an induced voltage generating coil in FIG. 12;

FIG. 18 is a diagram schematically illustrating another example of the configuration of the induced voltage generating coil in FIG. 12;

FIG. 19 is a waveform diagram illustrating another example of the application pulse and the detection pulse emitted by the foreign substance detection unit in FIG. 9;

FIG. 20 is a waveform diagram illustrating another example of the application pulse and the detection pulse emitted by the foreign substance detection unit in FIG. 9;

FIG. 21A is a flowchart illustrating an example of a procedure of control processing performed by the charging device in FIG. 2;

FIG. 21B is a flowchart illustrating an example of a procedure of foreign substance detection processing in the control processing in FIG. 21A;

FIG. 21C is a flowchart illustrating another example of the procedure of foreign substance detection processing in the control processing in FIG. 21A;

FIG. 22 is a control block diagram illustrating an example of a configuration of a charging device according to a second embodiment;

FIG. 23 is a control block diagram illustrating an example of a configuration of a foreign substance detection unit in FIG. 22;

FIG. 24 is a waveform diagram illustrating an example of an application pulse and a detection pulse emitted by the foreign substance detection unit in FIG. 22;

FIG. 25 is a control block diagram illustrating an example of a configuration of a charging device according to a third embodiment; and

FIG. 26 is a control block diagram illustrating an example of a configuration of a foreign substance detection unit in FIG. 25.

### DETAILED DESCRIPTION

The following describes embodiments of a charging device (a contactless charging device), a control method for the charging device (charging method), a computer program, and a recording medium according to the present disclosure with reference to the drawings.

In the description of the present disclosure, a constituent element having the same or substantially the same function as a constituent element that has been previously described with reference to a previously described drawing is denoted by the same reference numeral, and description thereof may be appropriately omitted. Even in a case of representing the same or substantially the same portion, dimensions or ratios thereof may be different among the drawings. For example, from a viewpoint of securing visibility of the drawings, reference numerals may be given to only principal constituent elements in the description of the drawings, and even for a constituent element having the same or substantially the same function as a function that is previously described with reference to previous drawings, a reference numeral is not given in some cases.

In the description of the present disclosure, an alphanumeric character may be added to an end of a reference numeral to distinguish between constituent elements having the same or substantially the same function. Alternatively, in a case of not distinguish between a plurality of constituent elements having the same or substantially the same function, they may be collectively described while omitting the alphanumeric character added to the end of the reference numeral.

In the related art, there is known a charging device that moves a power transmission coil to a position of a power reception coil of a terminal device (charging target) with a built-in battery, and performs wireless charging (contactless charging) for the charging target by the power transmission coil. In such a charging device, there is a problem in that, if a conductive foreign substance such as a coin is present on a placement surface (placement part) on which the charging target is placed, the conductive foreign substance generates heat when receiving transmitted power from the charging device. On the other hand, regarding an echo signal from the charging target corresponding to a pulse emitted from the charging device, there is known a technique of detecting the conductive foreign substance on the placement surface using the fact that a frequency characteristic such as a Q value (Quality Factor) varies due to presence of the conductive foreign substance.

However, in a case in which the charging target is not placed on the placement surface, it is difficult to detect a foreign substance because there is no echo signal from a resonance circuit of the charging target. Additionally, even in a case in which the charging target is placed thereon, there is a problem in that it takes time to detect the conductive foreign substance based on the echo signal from the charging target. For example, there is a problem in that it takes time to detect a foreign substance because determination of a foreign substance is performed while considering response performance of the echo signal from the charging target and a reception power state of the charging target under charging with minimum transmission power. Furthermore, from a viewpoint of safety, there is a problem in that it takes time until transmitted power becomes maximum even in a case in which there is no conductive foreign substance such that the transmitted power is suppressed until it is determined that “there is no foreign substance”. As described above, there has been room for improvement in charging devices that perform wireless charging from a viewpoint of usability.

Thus, the present disclosure describes a charging device that can improve usability of wireless charging, a control method for the charging device, a computer program, and a recording medium. Specifically, the present disclosure describes a charging device that can detect a conductive foreign substance on the placement surface before the charging target of wireless charging is placed on the placement surface, a control method for the charging device, a computer program, and a recording medium. Additionally, the present disclosure describes a charging device that can notify a user that there is a foreign substance and prompt the user to remove the foreign substance before the charging target of wireless charging is placed on the placement surface, a control method for the charging device, a computer program, and a recording medium.

A wireless charging device (charging device 5) according to the present disclosure is a device that performs contactless charging, that is, wireless charging, for a charging target (for example, a terminal device 15) placed on a placement surface thereof (for example, an upper surface of a disposition plate 6). The wireless charging device according to the present disclosure may be represented as a contactless charging device.

In the present disclosure, wireless charging means that charging is performed in a wireless manner. The present disclosure describes a form in which wireless charging means charging by electromagnetic induction action, as an example. As an international standard of wireless charging, there is known the Qi standard formulated by Wireless Power Consortium (WPC). The Qi standard specifies charging by carrying low electric power (hereinafter, referred to as “low power charging”), and charging by carrying high electric power (hereinafter, referred to as “high power charging”). For example, low power charging is performed at 5 W at maximum, and high power charging is performed at 15 W at maximum. Low power transmission is called Baseline Power Profile (BPP), and high power charging is called Extended Power Profile (EPP).

In each embodiment described below, exemplified is a case in which the wireless charging device according to the present disclosure is configured as an onboard device mounted on a vehicle, but the embodiment is not limited thereto. The wireless charging device according to the present disclosure can also be implemented as various wireless chargers conforming to a standard such as the Qi standard, for example, such as a device used on a desk. Additionally, the wireless charging device according to the present disclosure may include an independent housing, or may be configured as part of another device or component, including a case of being configured as an onboard device. That is, the wireless charging device according to the present disclosure may be used in a state of being placed at an optional place, may be used in a state of being disposed in a detachable manner at a predetermined place, or may be used in a state of being incorporated in another device or component.

### First Embodiment

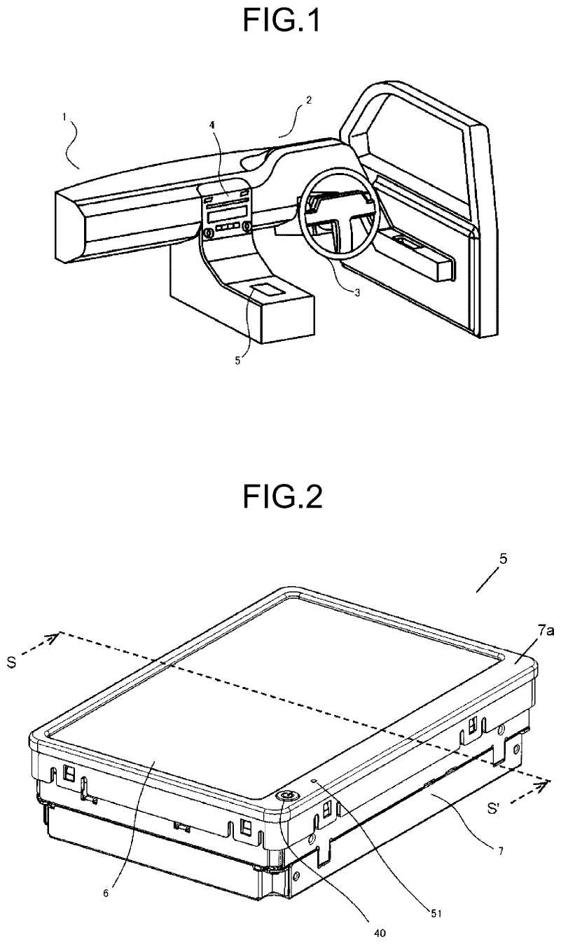

FIG. 1 is a perspective view illustrating an example of a state in which the charging device 5 (wireless charging device) according to the present disclosure is disposed in an automobile 1 (vehicle). In FIG. 1, a steering wheel 3 is disposed on a front side of an inner part of a compartment 2 of the automobile 1. On a lateral side of the steering wheel 3, an electronic device 4 is disposed to reproduce music or video, display an operation screen for receiving user's operation input, or display car navigation images. Additionally, the charging device 5 is disposed on a rear side of the electronic device 4 in the compartment 2.

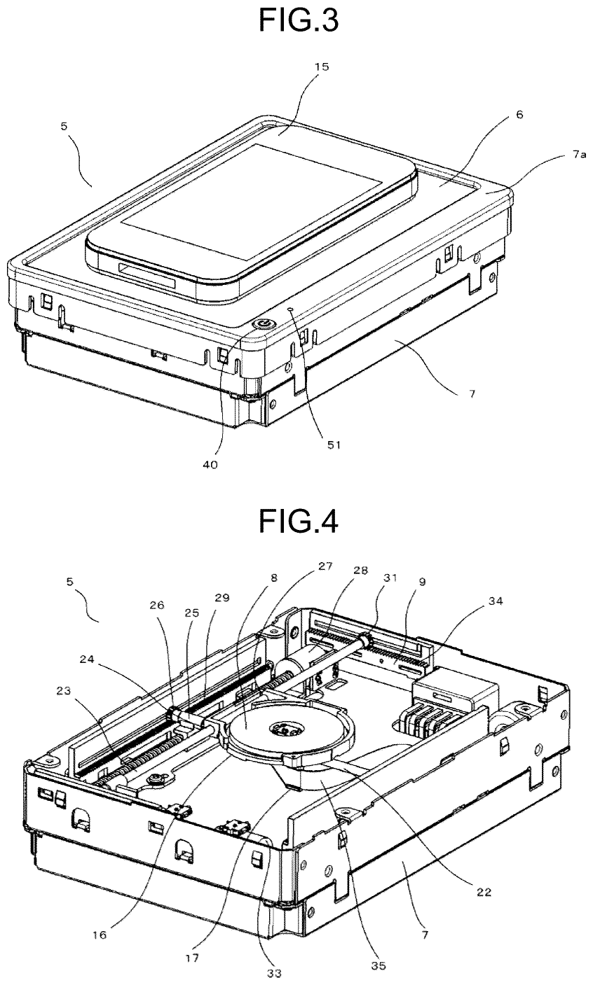

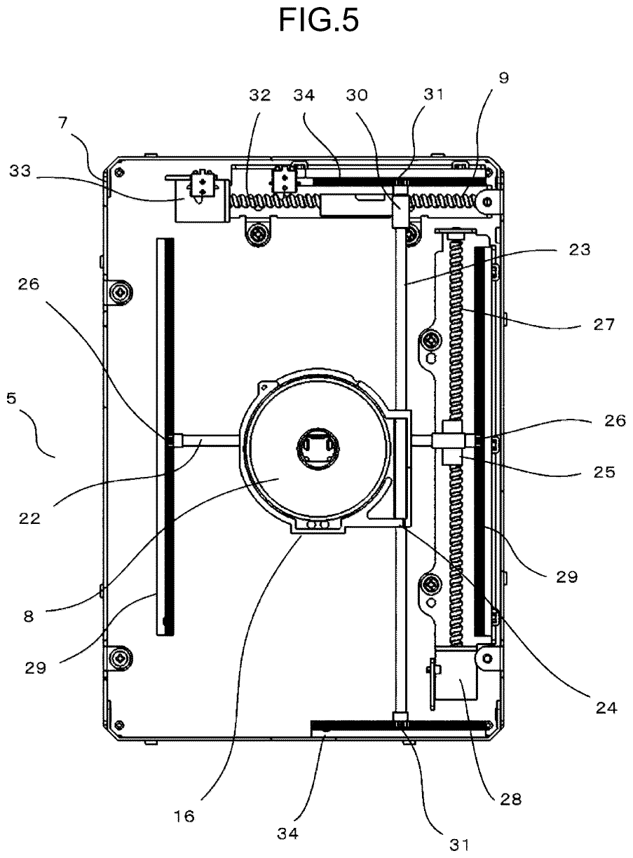

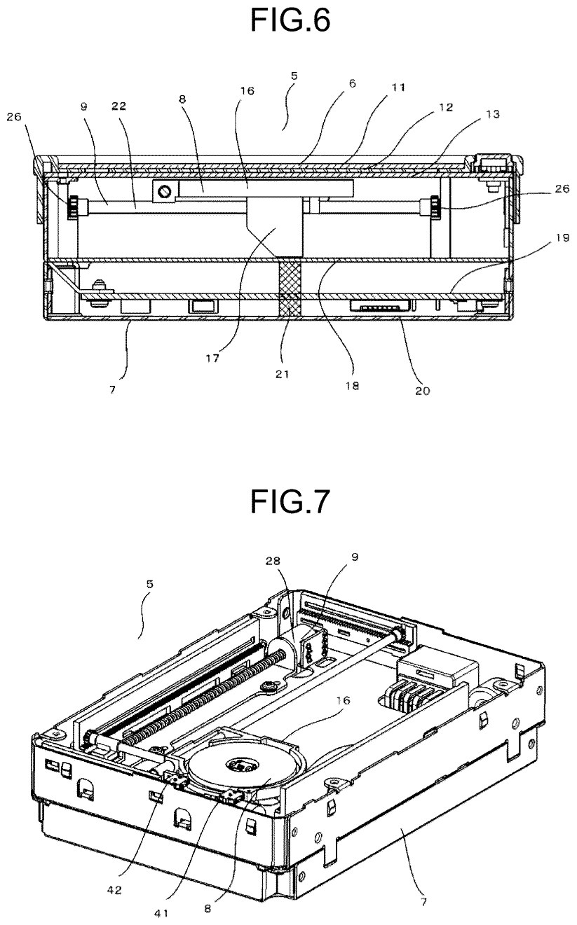

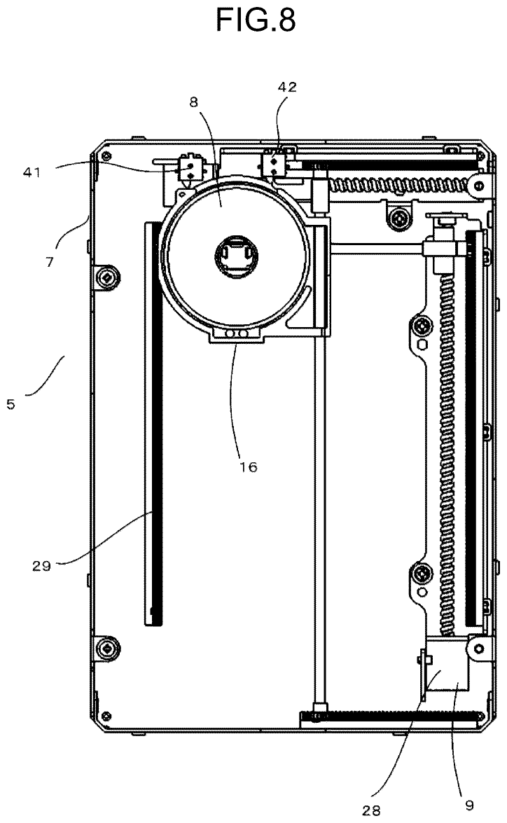

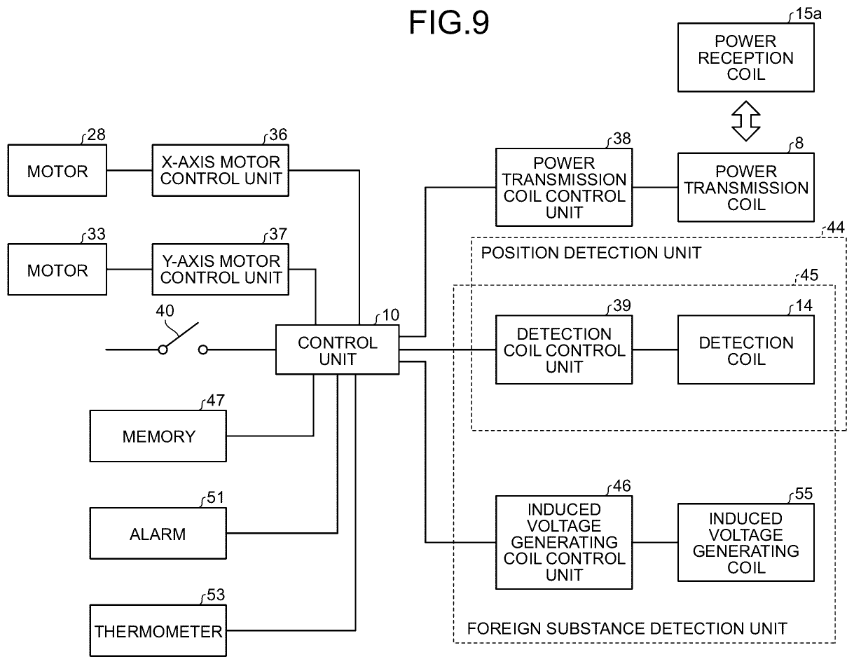

FIG. 2 is a perspective view illustrating an example of a configuration of the charging device 5 in FIG. 1. FIG. 3 is a perspective view illustrating an example of a state in which the terminal device 15 (charging target) is disposed on the charging device 5 in FIG. 2. FIG. 4 is a perspective view illustrating a state in which part of the charging device 5 in FIG. 2 is removed. FIG. 5 is a plan view illustrating the charging device 5 in the state of FIG. 4. FIG. 6 is a side cross-sectional view illustrating a cross section along a dashed line S-S′ of the charging device 5 in FIG. 2. FIG. 7 is a perspective view illustrating another state of the charging device 5 in FIG. 4. FIG. 8 is a plan view illustrating the charging device 5 in the state of FIG. 7. FIG. 9 is a control block diagram illustrating an example of a configuration of the charging device 5 according to a first embodiment.

As illustrated in FIG. 2 to FIG. 8, the charging device 5 includes a main body case 7, a power transmission coil 8, and a driving unit (driver) 9. The main body case 7 is, for example, a box-shaped housing of the charging device 5 including an upper surface on which the disposition plate 6 is placed. The power transmission coil 8 is disposed to be freely movable in a horizontal direction (along an X-Y plane) in a state of being opposed to a lower surface of the disposition plate 6 in the main body case 7. The driving unit 9 moves the power transmission coil 8 in the horizontal direction while being opposed to the lower surface of the disposition plate 6. Each of the power transmission coil 8 and the driving unit 9 is electrically connected to a control unit 10 (refer to FIG. 9).

The terminal device 15 as a target to be charged by the charging device 5 is an example of an electronic device with a built-in battery. The terminal device 15 is configured to be able to operate by using electric power from the built-in battery. This built-in battery is configured to be able to be charged by electric power that is wirelessly transmitted from the charging device 5. As the terminal device 15, for example, various electronic device such as a smartphone, a tablet terminal, an audio player, and a cellular telephone can be appropriately used.

The terminal device 15 includes at least a power reception coil 15a (refer to FIG. 9). The power reception coil 15a is configured to be able to receive electric power wirelessly transmitted from the charging device 5. The power reception coil 15a is, for example, an induction coil electromagnetically coupled to the power transmission coil 8 of the charging device 5. Electric power induced by the power reception coil 15a is supplied to the built-in battery of the terminal device 15. Herein, the power reception coil 15a is an example of a power reception unit.

As illustrated in FIG. 6, the disposition plate 6 has a configuration in which a front plate 11, a middle plate 12, and a back plate 13 are stacked.

Each of the front plate 11 and the back plate 13 is formed by using synthetic resin, for example. The middle plate 12 is, for example, made of ceramic. That is, magnetic flux from the power transmission coil 8 can pass through the disposition plate 6 in a direction toward the terminal device 15.

On the upper surface of the disposition plate 6, a placement surface on which the terminal device 15 to be charged is placed is disposed. That is, on the upper surface of the charging device 5, the placement surface on which the terminal device 15 to be wirelessly charged is placed is disposed. The present embodiment describes a form in which the placement surface is a partial region (disposition plate 6) of an outer surface of the main body case 7 (housing), and is a region having a two-dimensional plane shape, as an example.

In the description of the present embodiment, assumed is a case in which the upper surface of the disposition plate 6 (the placement surface for the charging target) is a two-dimensional plane along a plane defined by an X-direction and a Y-direction. Herein, the X-direction is described as a direction in which the power transmission coil 8 is moved along an X-axis direction drive shaft 22 (refer to FIG. 4 and FIG. 5). Similarly, the Y-direction is described as a direction in which the power transmission coil 8 is moved along a Y-axis direction drive shaft 23 (refer to FIG. 4 and FIG. 5). The X-direction and the Y-direction are directions orthogonal to each other along the upper surface (two-dimensional plane) of the disposition plate 6. A Z-direction orthogonal to the X-direction and the Y-direction is described as a direction agreeing with a thickness direction of the main body case 7. The Z-direction agrees with a direction in which the terminal device 15 placed on the placement surface is opposed to the charging device 5.

In the present embodiment, a direction from the back plate 13 toward the front plate 11 in the Z-direction, that is, a direction from the disposition plate 6 toward the terminal device 15 placed on the placement surface thereof, may be represented as “Z+ direction” or “upward” in some cases. Similarly, a direction from the terminal device 15 placed on the placement surface of the disposition plate 6 toward the placement surface may be represented as “Z-direction” or “downward” in some cases. A plane formed by the X-direction and the Y-direction, and an in-plane direction may be respectively represented as a “horizontal plane” and a “horizontal direction” in some cases.

In the present embodiment, “parallel”, “horizontal”, “vertical”, and “orthogonal” encompass not only a case of being completely “parallel”, “horizontal”, “vertical”, and “orthogonal” but also a case of being deviated from “parallel”, “horizontal”, “vertical”, and “orthogonal” within an error range. Additionally, “substantially” means being the same within an approximate range.

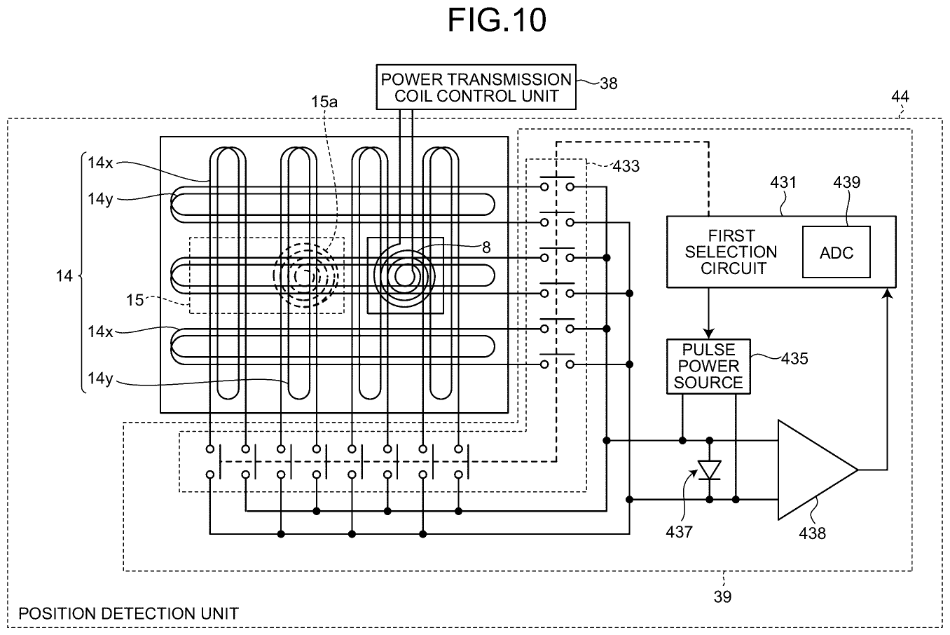

The power transmission coil 8 is a coil for transmitting electric power to the terminal device 15. Specifically, the power transmission coil 8 is a coil for charging that generates an AC magnetic field for charging, and supplies electric power to the power reception coil 15a by electromagnetic induction with the power reception coil 15a of the terminal device 15. As illustrated in, for example, FIG. 4, FIG. 5, and FIG. 10, the power transmission coil 8 has a ring shape around which a wire rod is wound in a spiral manner. That is, a cavity part is disposed at a center part of the power transmission coil 8. An outer peripheral side and a lower surface side of the power transmission coil 8 are held by a holding body 16 made of synthetic resin. As illustrated in FIG. 6, on the lower surface of the holding body 16, a support leg 17 extended toward a lower side of the power transmission coil 8 is integrally formed by synthetic resin. Additionally, for example, a gap of about 0.3 mm is disposed between a lower surface of the support leg 17 and an upper surface of a conductive support plate 18 disposed below the support leg 17 so that the lower surface of the support leg 17 is not brought into contact with the upper surface of the support plate 18 at the time of moving the power transmission coil 8.

A control board 19 and a lower plate 20 of the main body case 7 are disposed below the support plate 18. A support body 21 passing through the control board 19 is disposed between a lower surface of the support plate 18 and an upper surface of the lower plate 20. With the configuration of supporting the lower surface side of the support plate 18 by the lower plate 20 of the main body case 7 via the support body 21, strength against overweight is improved.

The driving unit 9 moves the power transmission coil 8 to a position opposed to the power reception coil 15a (refer to FIG. 9) of the terminal device 15 as a charging target placed on the placement surface.

As illustrated in FIG. 4 and FIG. 5, the driving unit 9 includes the X-axis direction drive shaft 22 and the Y-axis direction drive shaft 23. A middle portion of each of the X-axis direction drive shaft 22 and the Y-axis direction drive shaft 23 is in physically contact with a portion of the holding body 16 different from a portion by which the power transmission coil 8 is held. That is, on the holding body 16, a through hole (not illustrated) through which the X-axis direction drive shaft 22 passes and a through hole 24 through which the Y-axis direction drive shaft 23 passes are disposed in a crossing state with a predetermined interval in a vertical direction. The X-axis direction drive shaft 22 and the Y-axis direction drive shaft 23 are in contact with these through holes.

A worm wheel 25 is disposed on one end side of the X-axis direction drive shaft 22. Gears 26 are disposed at both ends of the X-axis direction drive shaft 22. The worm wheel 25 is engaged with a worm 27. This worm 27 is coupled to a motor 28. Each of the gears 26 on both sides is engaged with a gear wheel plate 29. Due to this, when the motor 28 is driven, the worm 27 rotates, and the worm wheel 25 moves in the X-axis direction together with the X-axis direction drive shaft 22 accordingly. The power transmission coil 8 integrated with the X-axis direction drive shaft 22 then moves in the X-axis direction.

A worm wheel 30 is disposed on one end side of the Y-axis direction drive shaft 23. Gears 31 are disposed on both ends of the Y-axis direction drive shaft 23. The worm wheel 30 is engaged with a worm 32. This worm 32 is coupled to a motor 33. Each of the gears 31 on both sides is engaged with a gear wheel plate 34. Due to this, when the motor 33 is driven, the worm 32 rotates, and the worm wheel 30 moves in the Y-axis direction together with the Y-axis direction drive shaft 23 accordingly. The power transmission coil 8 integrated with the Y-axis direction drive shaft 23 then moves in the Y-axis direction.

Flexible wiring 35 illustrated in FIG. 4 energizes the power transmission coil 8. That is, the flexible wiring 35 is electrically connected to a power source (not illustrated). This power source may be an external power source disposed outside the charging device 5 such as a vehicle-mounted battery or a commercial power source, or may be a battery (not illustrated) mounted on the charging device 5. An end part of the flexible wiring 35 is fixed to a side surface of the support leg 17 described above.

For example, as illustrated in FIG. 2 and FIG. 3, an upward projecting part 7a projecting upward from the disposition plate 6 is disposed on an outer peripheral portion of the disposition plate 6 of the main body case 7. That is, the placement surface for a charging target in the charging device 5 means an upper surface portion of the disposition plate 6 surrounded by the upward projecting part 7a. On the upward projecting part 7a, a power switch 40 and an alarm 51 are disposed.

The power switch 40 is, for example, a switch configured to be able to detect a press by a user, but may be another switch such as a slider. The charging device 5 may be turned on in conjunction with accessory-on (ACC-ON) of the automobile 1, for example, and the power switch 40 is not an essential configuration.

The alarm 51 is configured to put out an alert to the user. By way of example, the alarm 51 includes a light source such as a red light source, and notifies the user of presence of a conductive foreign substance by driving the light source (lighting or blinking). The alarm 51 may be a speaker or a buzzer that emits a warning sound when being driven. Alternatively, the alarm 51 may be configured as a display unit that displays a notification that the conductive foreign substance is detected, or a notification for prompting the user to remove the conductive foreign substance.

As illustrated in FIG. 9, in addition to the configuration described above, the charging device 5 further includes the control unit 10, a detection coil 14 (position detection coil), an X-axis motor control unit 36, a Y-axis motor control unit 37, a power transmission coil control unit 38, a detection coil control unit 39, an induced voltage generating coil control unit 46, a memory 47, a thermometer 53, and an induced voltage generating coil 55 (foreign substance detection coil). The X-axis motor control unit 36 and the Y-axis motor control unit 37 may be integrally configured. Alternatively, the charging device 5 may be configured to move the power transmission coil 8 in a uniaxial direction of the X-axis or the Y-axis. Similarly, the motors 28 and 33 may be implemented by one common motor.

The control unit 10 is a processor that controls operation of each part of the charging device 5. The control unit 10 implements functions of the charging device 5 such as a position detection function, a foreign substance detection function, a communication function, a driving function, and a charging function by reading out a control program stored in a read only memory (ROM) and the like of the memory 47, for example, and executing a control program loaded into a random access memory (RAN) of the memory 47.

As a processor that implements the control unit 10, various processors such as a central processing unit (CPU), a graphics processing unit (GPU), an application specific integrated circuit (ASIC), and a field programmable gate array (FPGA) can be appropriately used.

For example, regarding the position detection function, the control unit 10 is configured to control a position detection unit 44 to detect a position of the power reception coil 15a. For example, the control unit 10 outputs a signal for generating a magnetic field for detection to the detection coil control unit 39 of the position detection unit 44, and causes the magnetic field for detection to be generated selectively and successively from each coil of the detection coil 14. The control unit 10 is configured to identify an arrangement position of the terminal device 15 as a charging target, that is, the position of the power reception coil 15a, based on an echo signal responded from the power reception coil 15a in response to the magnetic field for detection and detected by each coil of the detection coil 14.

For example, regarding the foreign substance detection function, the control unit 10 is configured to control a foreign substance detection unit 45, and detect, from presence and a position of the conductive foreign substance, at least the presence thereof on the upper surface of the disposition plate 6 (placement surface for a charging target). For example, the control unit 10 outputs a signal for generating the magnetic field for detection to the induced voltage generating coil control unit 46 of the foreign substance detection unit 45, and causes the magnetic field for detection to be generated selectively and successively from each coil of the induced voltage generating coil 55. The control unit 10 is configured to identify presence/absence or a position of the conductive foreign substance on the placement surface for a charging target based on variation of an induction current of each coil of the detection coil 14 or an induced voltage converted from the induction current caused by a magnetic field that is generated from the conductive foreign substance in response to the magnetic field for detection.

For example, regarding the communication function, the control unit 10 controls the power transmission coil 8, and communicates with the power reception coil 15a. For example, the control unit 10 is configured to communicate with the terminal device 15 via the power transmission coil 8 when the power transmission coil 8 is moved to a position opposed to the power reception coil 15a of the terminal device 15 by control of the driving function.

The following describes the communication function between the charging device 5 and the terminal device 15 according to the embodiment. The power transmission coil 8 of the charging device 5 can be electromagnetically coupled to the power reception coil 15a of the terminal device 15, and the charging device 5 and the terminal device 15 communicate with each other by using this electromagnetic coupling. For example, by adjusting loads on the power transmission coil 8 and the power reception coil 15a, the charging device 5 and the terminal device 15 transmit data as variation in a coupling field. Specifically, the charging device 5 transmits data modulated by Frequency Shift Keying (FSK) to the terminal device 15. When the terminal device 15 receives data modulated by load modulation, the charging device 5 demodulates the data. Through these pieces of processing, information is enabled to be exchanged between the charging device 5 and the terminal device 15.

The communication between the charging device 5 and the terminal device 15 may be implemented by communication corresponding to various standards such as 4G, 5G, 6G, Wi-Fi (registered trademark), Bluetooth (registered trademark), and infrared communication.

For example, regarding the driving function, the control unit 10 controls the motors 28 and 33 via the X-axis motor control unit 36 and the Y-axis motor control unit 37, and changes relative positions of the power transmission coil 8 and the power reception coil 15a based on a position of the detected power reception coil 15a. By way of example, the control unit 10 moves the power transmission coil 8 to be disposed at a charging start position corresponding to the position at which the terminal device 15 as a charging target is detected. Herein, the charging start position is a position at which the terminal device 15 is placed, that is, a position opposed to a detection position of the power reception coil 15a. Typically, positions of the power transmission coil 8 and the power reception coil 15a in the horizontal direction at the charging start position, that is, positions viewed from the upper surface side, agree or substantially agree with each other. That is, at the charging start position, center positions of the power transmission coil 8 and the power reception coil 15a match or substantially match each other.

For example, regarding the charging function, the control unit 10 is configured to output, to the power transmission coil control unit 38, a signal for causing a magnetic field for power transmission to be generated in the power transmission coil 8, and transmit electric power from the power transmission coil 8 to the power reception coil 15a. After the power transmission coil 8 is disposed at the charging start position, the control unit 10 starts charging control for transmitting electric power to the terminal device 15.

As a hardware configuration of the memory 47, various storage media or storage devices such as a ROM, a hard disk drive (HDD), a solid state drive (SSD), and a Flash memory can be appropriately used. A RAM that temporarily stores data being operated is further provided in the memory 47. The memory 47 stores various kinds of data or control programs used by the control unit 10.

The thermometer 53 is configured to be able to measure an ambient temperature of the charging device 5. Measurement data of the thermometer 53 is output to the control unit 10.

FIG. 10 is a control block diagram illustrating an example of a configuration of the position detection unit 44 in FIG. 9. In the charging device 5 according to the present embodiment, the position detection unit 44 includes the detection coil 14 and the detection coil control unit 39.

The detection coil 14 is a coil group for detecting the position of the power reception coil 15a of the terminal device 15 on the placement surface. The position of the power reception coil 15a is represented by a position on a two-dimensional plane constituted of an XY-plane along the placement surface (upper surface of the disposition plate 6). In a case in which the power reception coil 15a is an induction coil having a circular ring shape as illustrated in FIG. 10, for example, the position of the power reception coil 15a can be defined as a position of a center point of this circular ring. The detection coil 14 is arranged along the placement surface and below the placement surface in the main body case 7 of the charging device 5. For example, the detection coil 14 is a plurality of coils disposed on the middle plate 12. For example, the coils of the detection coil 14 are arranged in a matrix in directions intersecting each other.

The present embodiment exemplifies a case in which the detection coil 14 is disposed on the middle plate 12, but the embodiment is not limited thereto. The detection coil 14 may be disposed on the front plate 11 or the back plate 13.

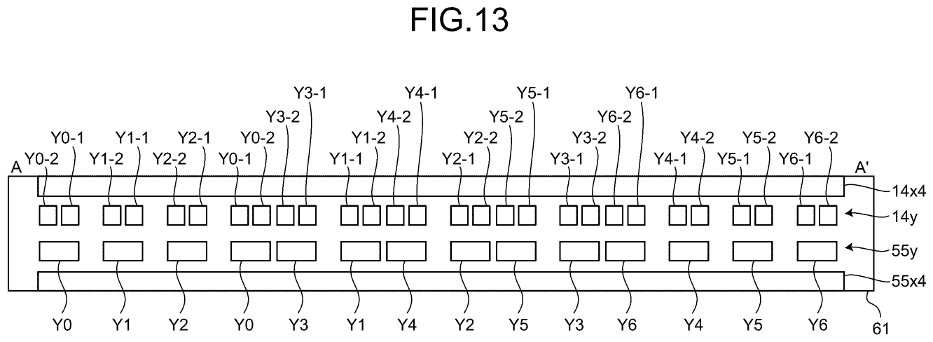

By way of example, a plurality of detection coils 14x and 14y are respectively disposed in the X-direction and the Y-direction on the middle plate 12 (refer to FIG. 13 to FIG. 15). In the present disclosure, both coils may be collectively and simply referred to as the detection coil 14 in some cases. The detection coil 14x detects positions of the power transmission coil 8 and the power reception coil 15a in the X-direction. Each of the detection coils 14x has an elongated loop shape in the Y-axis direction. The detection coils 14x are fixed to the middle plate 12 at predetermined intervals. The detection coil 14y detects positions of the power transmission coil 8 and the power reception coil 15a in the Y-direction. Each of the detection coils 14y has an elongated loop shape in the X-axis direction. The detection coils 14y are fixed to the middle plate 12 at predetermined intervals.

The detection coil control unit 39 includes a first selection circuit 431, a switching circuit 433, a pulse power source 435, a diode 437, and an amplifier 438. The first selection circuit 431 includes an A/D converter (ADC) 439.

An output node of the first selection circuit 431 is electrically connected to each control node of the switching circuit 433 and the pulse power source 435. Each switch of the switching circuit 433 is disposed between each detection coil 14 and the amplifier 438. Specifically, one end of each detection coil 14 is electrically connected to one of a pair of input nodes of the amplifier 438 via the switch. The other end of each detection coil 14 is electrically connected to the other one of the pair of input nodes of the amplifier 438 via another switch. A pair of output nodes of the pulse power source 435 are electrically connected to the pair of input nodes of the amplifier 438, respectively. The diode 437 is electrically connected between the pair of output nodes of the pulse power source 435. That is, the diode 437 is disposed between the pair of input nodes of the amplifier 438. An output node of the amplifier 438 is electrically connected to an input node of the first selection circuit 431. Specifically, the output node of the amplifier 438 is electrically connected to an input node of the ADC 439 of the first selection circuit 431.

The first selection circuit 431 controls the switching circuit 433 to connect the detection coil 14 to the amplifier 438 in order, and detects the position of the power transmission coil 8 or the power reception coil 15a. Every time each of the detection coils 14x and 14y is connected to the amplifier 438, the first selection circuit 431 causes the pulse power source 435 to output a pulse signal to the detection coil 14 connected to the amplifier 438. In a case in which an echo signal is detected after a specific delay time has elapsed from the pulse signal, the first selection circuit 431 determines that the power transmission coil 8 or the power reception coil 15a is approaching the detection coil 14.

The switching circuit 433 switches the detection coil 14 to be connected to the amplifier 438 in accordance with a control signal from the first selection circuit 431.

The pulse power source 435 generates a pulse signal at a predetermined timing, and supplies the generated pulse signal to the detection coil 14 connected via the switching circuit 433. The pulse power source 435 is electrically connected to a power source (not illustrated). This power source may be an external power source disposed outside the charging device 5 such as a vehicle-mounted battery or a commercial power source, or may be a battery (not illustrated) mounted on the charging device 5.

The diode 437 limits a signal level of the pulse signal input to the amplifier 438 from the pulse power source 435. Herein, the level of the pulse signal output from the pulse power source 435 to the detection coil 14 is significantly large as compared with the echo signal from the power transmission coil 8 or the power reception coil 15a. The echo signal at a small signal level is input to the amplifier 438 without limitation.

The amplifier 438 receives and amplifies the echo signal that is excited by the pulse signal supplied from the pulse power source 435 to the detection coil 14, and is output to the detection coil 14 from the power transmission coil 8 and the power reception coil 15a. The amplifier 438 also receives and amplifies the pulse signal from the pulse power source 435 via the diode 437. The amplifier 438 outputs the amplified echo signal and pulse signal to the first selection circuit 431.

The ADC 439 converts the echo signal from the amplifier 438 into a digital signal.

As described above, the first selection circuit 431 performs an arithmetic operation on the digital signal from the ADC 439 to detect the echo signal. Specifically, the first selection circuit 431 detects, as the echo signal, the signal that is input after the specific delay time has elapsed from the pulse signal, and determines whether the power transmission coil 8 or the power reception coil 15a is approaching each detection coil 14 based on the level of the echo signal.

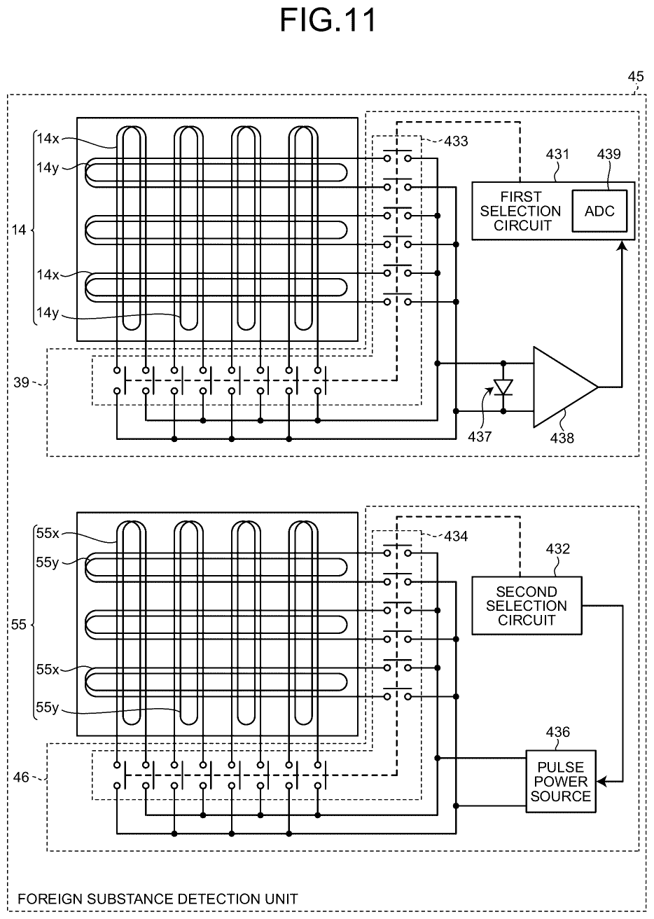

FIG. 11 is a control block diagram illustrating an example of a configuration of the foreign substance detection unit 45 in FIG. 9. In the charging device 5 according to the present embodiment, the foreign substance detection unit 45 includes the detection coil 14, the detection coil control unit 39, the induced voltage generating coil control unit 46, and the induced voltage generating coil 55.

The detection coil 14 and the detection coil control unit 39 of the foreign substance detection unit 45 are the same as those in the position detection unit 44 except that the pulse power source 435 is not disposed in the detection coil control unit 39, so that description thereof will not be repeated.

The induced voltage generating coil 55 is a coil group that generates induced voltage for causing the detection coil 14 to detect presence or a position of the conductive foreign substance on the placement surface. The induced voltage generating coil 55 is arranged below the placement surface and along the placement surface in the main body case 7 of the charging device 5. For example, the induced voltage generating coil 55 is a plurality of coils disposed on the middle plate 12. For example, the coils of the induced voltage generating coil 55 are arranged in a matrix in directions intersecting each other.

The present embodiment exemplifies a case in which the induced voltage generating coil 55 is disposed on the middle plate 12, but the embodiment is not limited thereto. The induced voltage generating coil 55 may be disposed on the front plate 11 or the back plate 13. The induced voltage generating coil 55 may be disposed on the same member as that of the detection coil 14, or they may be disposed on members different from each other.

By way of example, the induced voltage generating coil 55 has a common structure with the detection coil 14. That is, the induced voltage generating coil 55 includes a plurality of coils corresponding to the coils of the detection coil 14. For example, a plurality of induced voltage generating coils 55x and 55y are respectively disposed in the X-direction and the Y-direction on the middle plate 12 (refer to FIG. 13 to FIG. 15). In the present disclosure, both coils may be collectively and simply referred to as the induced voltage generating coil 55 in some cases. The induced voltage generating coils 55x are fixed to the middle plate 12 at predetermined intervals, and each have an elongated loop shape in the Y-axis direction. The induced voltage generating coils 55y are fixed to the middle plate 12 at predetermined intervals, and each have an elongated loop shape in the X-axis direction.

The induced voltage generating coil control unit 46 includes a second selection circuit 432, a switching circuit 434, and a pulse power source 436.

An output node of the second selection circuit 432 is electrically connected to each control node of the switching circuit 434 and the pulse power source 436. Each switch of the switching circuit 434 is disposed between each induced voltage generating coil 55 and the pulse power source 436. Specifically, one end of each induced voltage generating coil 55 is electrically connected to one of a pair of output nodes of the pulse power source 436 via the switch. The other end of each induced voltage generating coil 55 is electrically connected to the other one of the pair of output nodes of the pulse power source 436 via another switch.

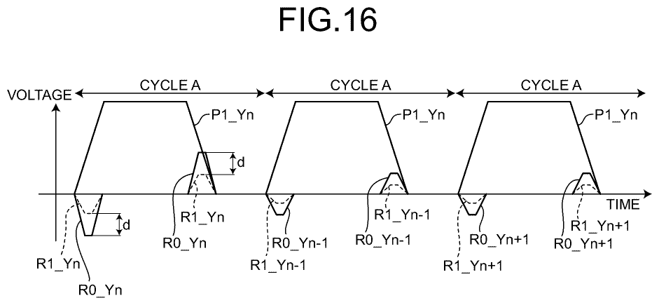

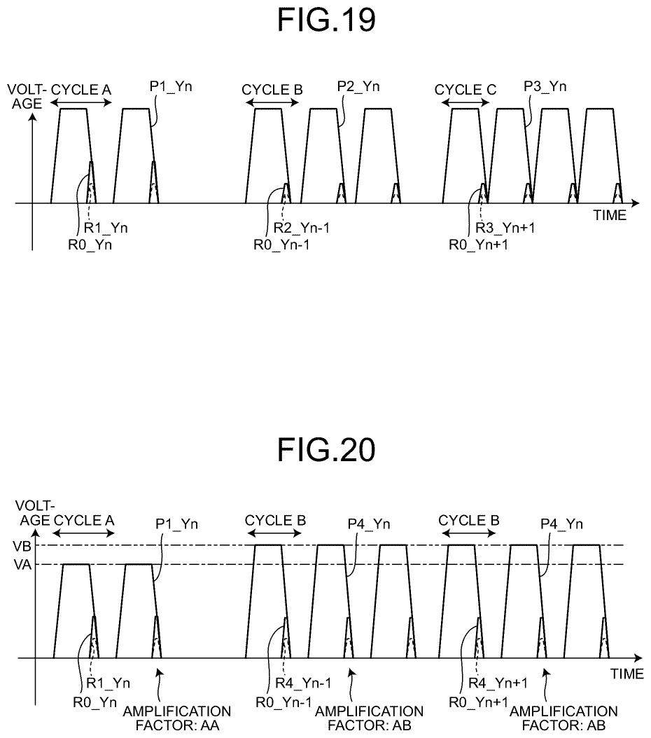

The second selection circuit 432 controls the switching circuit 434 to connect the induced voltage generating coil 55 to the pulse power source 436 in order, and detects presence or a position of the conductive foreign substance. Every time each of the induced voltage generating coils 55x and 55y is connected to the pulse power source 436, the second selection circuit 432 causes the pulse power source 436 to output a pulse signal to the connected induced voltage generating coil 55 (refer to FIG. 16, FIG. 19, and FIG. 20). In other words, by applying the pulse signal from the pulse power source 436 to the induced voltage generating coil 55 as a target, the second selection circuit 432 causes an induction current to be generated in the detection coil 14 in the vicinity of the induced voltage generating coil 55. In the foreign substance detection unit 45, the first selection circuit 431 determines that the conductive foreign substance is close to the detection coil 14 based on variation of the induced voltage (a difference in voltage amplitude) caused by the induction current generated in the detection coil 14 (refer to FIG. 16, FIG. 19, and FIG. 20).

The switching circuit 434 switches the induced voltage generating coil 55 to be connected to the pulse power source 436 in accordance with a control signal from the second selection circuit 432.

The pulse power source 436 generates a pulse signal at a predetermined timing, and supplies the generated pulse signal to the induced voltage generating coil 55 connected via the switching circuit 434. The pulse power source 436 is electrically connected to a power source (not illustrated). This power source may be an external power source disposed outside the charging device 5 such as a vehicle-mounted battery or a commercial power source, or may be a battery (not illustrated) mounted on the charging device 5.

In this way, the second selection circuit 432 applies the pulse signal for generating induced voltage to the induced voltage generating coil 55. The first selection circuit 431 detects the induced voltage based on the induction current that is generated in the detection coil 14 by electromagnetic induction from the induced voltage generating coil 55. Specifically, the first selection circuit 431 detects whether the conductive foreign substance close to the detection coil 14 is present based on whether the voltage amplitude of the induced voltage generated in the detection coil 14 has varied depending on whether the conductive foreign substance is present on the placement surface.

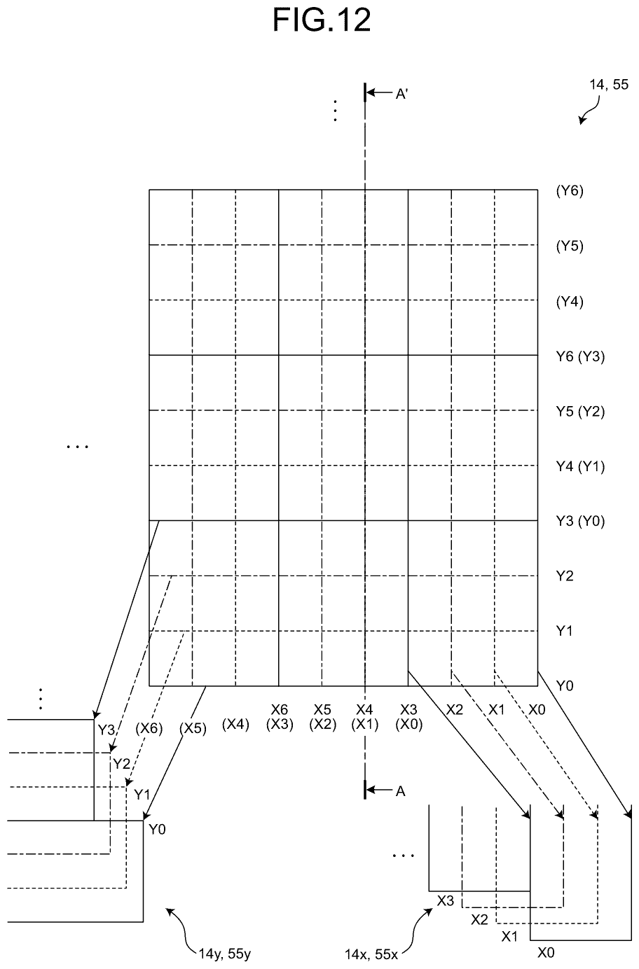

FIG. 12 is a diagram schematically illustrating an example of the configuration of the foreign substance detection unit 45 in FIG. 9. Specifically, FIG. 12 schematically illustrates the configurations of the detection coil 14 and the induced voltage generating coil 55 in the foreign substance detection unit 45. In each of the detection coil 14 and the induced voltage generating coil 55, as illustrated in FIG. 12, each of the coils is disposed to overlap an adjacent coil by ⅔, that is, disposed at a position shifted from the adjacent coil by ⅓, in each of the X-axis direction and the Y-axis direction. For example, the detection coils 14x (induced voltage generating coils 55x) of “X0” and “X1” overlap each other by ⅔. For example, the detection coils 14x (induced voltage generating coils 55x) of “X0” and “X2” overlap each other by ⅓. For example, the detection coils 14x (induced voltage generating coils 55x) of “X0” and “X3” are adjacent coils, and do not overlap each other. In the example of FIG. 12, a position of the detection coil 14x (induced voltage generating coil 55x) of “X0” on a side of the detection coil 14x (induced voltage generating coil 55x) of “X3” is represented as “(X0)”.

For example, it is assumed that a coil of “X0” of the detection coil 14 is present immediately below or right above a coil of “X0” of the induced voltage generating coil 55. That is, the coil of “X0” of the detection coil 14 is a coil overlapping (coil disposed to be opposed to) the coil of “X0” of the induced voltage generating coil 55. In this configuration, if the conductive foreign substance is present on or inside the coil of “X0”, the voltage amplitude of the detected induced voltage is increased or decreased as compared with a case in which the conductive foreign substance is not present depending on whether the conductive foreign substance is a magnetic body or a diamagnetic body at the time of rising or falling of the pulse signal. Thus, the first selection circuit 431 compares the voltage amplitude of the detected induced voltage with voltage amplitude of induced voltage previously stored in the memory 47 in a case in which the conductive foreign substance is not present, and can detect the conductive foreign substance present on the placement surface in a case in which there is a difference in the voltage amplitude. Details about detection of the conductive foreign substance will be described later.

The detection coil 14 and the induced voltage generating coil 55 have a common configuration, for example, but the configuration is not necessarily common such that the number of windings of each coil may be different between the detection coil 14 and the induced voltage generating coil 55.

FIG. 13 is a diagram illustrating an example of a cross section along a dashed line A-A′ of the foreign substance detection unit 45 in FIG. 12. A substrate 61 in FIG. 13 constitutes the middle plate 12, for example, but may constitute the front plate 11 or the back plate 13. As illustrated in FIG. 13, the detection coils 14x and 14y are disposed on a surface side of the substrate 61. The induced voltage generating coils 55x and 55y are disposed on a back surface side of the substrate 61. FIG. 13 exemplifies the detection coil 14x of “X4” formed in the first layer from the top of the substrate 61, the detection coils 14y of “Y0” to “Y6” formed in the second layer, the induced voltage generating coils 55y of “Y0” to “Y6” formed in the third layer, and the induced voltage generating coil 55x of “X4” formed in the fourth layer. By way of example, each coil of the induced voltage generating coil 55 may be a coil the number of windings of which is smaller (for example, one) than that of each coil (for example, two) of the detection coil 14 at a corresponding position (immediately below or right above). Each coil of the induced voltage generating coil 55 is a coil overlapping each coil of the detection coil 14 at a corresponding position (immediately below or right above). In the example of FIG. 13, at a position immediately below the detection coil 14y of “Y0” with two windings of “Y0-1”→“Y0-1”→“Y0-2”→“Y0-2”, the induced voltage generating coil 55y of “Y0” with one winding of “Y0”→“Y0” is disposed.

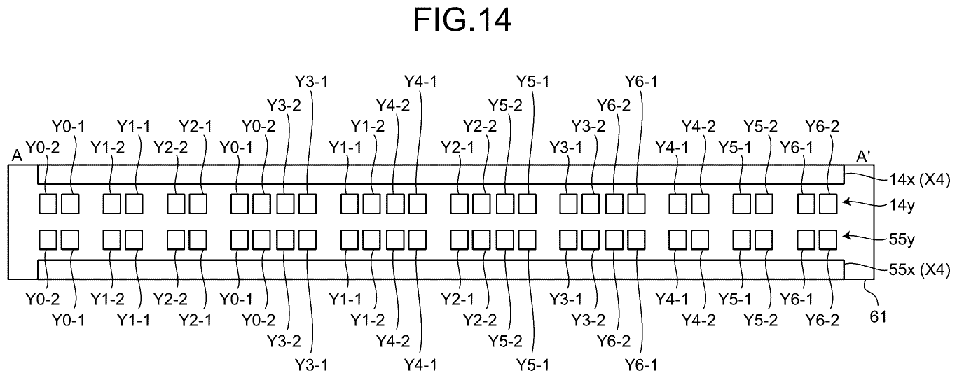

FIG. 14 is a diagram illustrating another example of a cross section along the dashed line A-A′ of the foreign substance detection unit 45 in FIG. 12. The substrate 61 in FIG. 14 constitutes the middle plate 12, for example, but may constitute the front plate 11 or the back plate 13. As illustrated in FIG. 14, the detection coils 14x and 14y are disposed on the surface side of the substrate 61. The induced voltage generating coils 55x and 55y are disposed on the back surface side of the substrate 61. By way of example, each coil of the induced voltage generating coil 55 may be a coil the number of windings of which is the same (for example, two) as that of each coil with two windings of the detection coil 14 at a corresponding position (immediately below or right above). In the example of FIG. 13, at a position immediately below the detection coil 14y of “Y0” with two windings of “Y0-1”→“Y0-1”, “Y0-2”→“Y0-2”, the induced voltage generating coil 55y of “Y0” with two windings of “Y0-1”→“Y0-1”→“Y0-2”→“Y0-2” is disposed.

As described above, intensity of the generated magnetic field is increased by increasing the number of windings of each coil of the induced voltage generating coil 55, so that the induced voltage and a variation amount thereof can be increased, and detection accuracy or detection sensitivity for the conductive foreign substance can be improved.

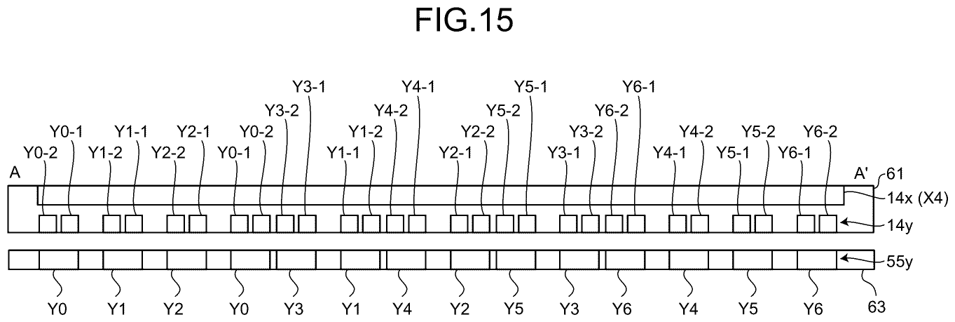

The detection coil 14 and the induced voltage generating coil 55 are formed on the same substrate 61 (for example, the middle plate 12), for example, but the embodiment is not limited thereto. FIG. 15 is a diagram illustrating another example of a cross section along the dashed line A-A′ of the foreign substance detection unit 45 in FIG. 12. The substrates 61 and 63 in FIG. 15 constitute the middle plate 12, for example, but may constitute the front plate 11 or the back plate 13. One of the substrates 61 and 63 in FIG. 15 may constitute the front plate 11, the middle plate 12, or the back plate 13, and the other one may constitute a member different from the substrate 61 among the front plate 11, the middle plate 12, and the back plate 13. Alternatively, the substrate 61 may constitute the middle plate 12, and the substrate 63 may be inserted between the middle plate 12 and the front plate 11 or the back plate 13. As illustrated in FIG. 15, the detection coils 14x and 14y are respectively disposed on the front and back surfaces of the substrate 61. The induced voltage generating coils 55x and 55y are disposed on the substrate 63. By way of example, the disposition plate 6 may be configured by overlapping the substrate 61 on which the detection coil 14 is formed and the substrate 63 on which the induced voltage generating coil 55 is formed. That is, the detection coil 14 and the induced voltage generating coil 55 may be respectively formed on the substrates 61 and 63 different from each other. Herein, the substrates 61 and 63 may be overlapped each other at an interval of 10 mm or less. FIG. 15 does not illustrate the induced voltage generating coil 55x. Herein, the induced voltage generating coil 55x may be formed on the substrate 63 on which the induced voltage generating coil 55y is disposed, or may be formed on another different substrate. In the configuration of FIG. 15, the induced voltage generating coil 55 may be configured such that any one of the induced voltage generating coil 55x and the induced voltage generating coil 55y is not disposed. With this configuration, the induced voltage generating coil 55 can be downsized or made thinner, so that the charging device 5 can be downsized or made thinner, or a degree of freedom in design such as a shape of the charging device 5 or arrangement of constituent elements can be improved. In the configuration of FIG. 15, the substrate 63 on which the induced voltage generating coil 55 is formed may be a flexible substrate, for example. As described above, with the configuration in which the detection coil 14 and the induced voltage generating coil 55 are formed on different substrates, the disposition plate 6 can be made thinner. That is, the charging device 5 can be downsized.

Any of the detection coil 14 and the induced voltage generating coil 55 may be disposed on an upper side.

The following describes measurement of induced voltage in accordance with detection of the conductive foreign substance.

For the foreign substance detection unit 45, the control unit 10 performs measurement of induced voltage in accordance with detection of the conductive foreign substance for each combination of the coils of the detection coil 14 and the induced voltage generating coil 55 that is determined advance and stored in the memory 47.

FIG. 16 is a waveform diagram illustrating an example of an application pulse P and a detection pulse R emitted by the foreign substance detection unit 45 in FIG. 9. In measurement of induced voltage, the control unit 10 applies a pulse signal (application pulse P1) to the induced voltage generating coil 55 from the induced voltage generating coil control unit 46, and acquires, by the detection coil control unit 39, voltage amplitude (detection pulse R1) of induced voltage generated in the detection coil 14 in accordance with a magnetic field generated by the induced voltage generating coil 55. FIG. 16 exemplifies measurement of induced voltage in accordance with the Y-direction, but the same applies to measurement of induced voltage in accordance with the X-direction.

In FIG. 16, an application pulse P1_Yn (n=0 to 6) indicates a pulse signal applied to the induced voltage generating coil 55 of “Yn”. A detection pulse R1_Yn (n=0 to 6) indicates voltage amplitude of induced voltage generated in the detection coil 14 of “Yn” in a case in which the conductive foreign substance is present. A detection pulse R0_Yn (n=0 to 6) indicates voltage amplitude of induced voltage generated in the detection coil 14 of “Yn” in a case in which the conductive foreign substance is not present. To simplify the description, FIG. 16 exemplifies the detection pulse R that can be acquired via the amplifier 438 in a case in which the diode 437 is not disposed in the configuration of FIG. 10 and FIG. 11. For example, in a case in which the diode 437 is disposed, the detection pulse R is any one of a waveform obtained by reversing, to a positive side, a waveform generated on a negative side with rising of the application pulse P1 in FIG. 16 and a waveform generated on the positive side with falling thereof, in accordance with a direction of an applied current.

By way of example, the control unit 10 applies the application pulse P1_Yn to the optional induced voltage generating coil 55 of “Yn” on a regular cycle of a cycle A, and measures the detection pulse R1_Yn generated with rising/falling of the application pulse P1_Yn in the detection coil 14 of “Yn” immediately below or right above the induced voltage generating coil 55 of “Yn”.

The control unit 10 acquires a difference between the detection pulse R0_Yn stored in the memory 47 and the measured detection pulse R1_Yn as a variation amount d of the voltage amplitude of the induced voltage. In a case in which the conductive foreign substance is not present, it is assumed that the detection pulse R0_Yn measured in each detection coil 14 of “Yn” when the application pulse P1_Yn is applied to each induced voltage generating coil 55 of “Yn” is stored in the memory 47 in advance, for example.

The control unit 10 may perform measurement of the detection pulse R1_Yn on any one of the positive side and the negative side, that is, at any one of timings of rising/falling of the application pulse P1_Yn, or may measure both of them by further applying the application pulse P having a waveform obtained by reversing positive and negative of the application pulse P1 in FIG. 16 by switching the direction of the current, for example. For example, in a configuration of determining whether the conductive foreign substance is present, the control unit 10 may measure the detection pulse R1_Yn on at least one of the positive side and the negative side, and detects the conductive foreign substance in a case in which the variation amount d thereof is detected. For example, in a configuration of determining a position of the conductive foreign substance, the control unit 10 measures both detection pulses R1_Yn on the positive side and the negative side. That is, in the configuration of determining a position of the conductive foreign substance, the control unit 10 acquires the positive/negative variation amount d of the detection pulse R1_Yn for each of rising/falling of the application pulse P1_Yn.

As exemplified in FIG. 16, the control unit 10 may apply the application pulse P1_Yn to the optional induced voltage generating coil 55 of “Yn” on a regular cycle of the cycle A, and measure the detection pulse R1_Yn by successively switching among the detection coil 14 of “Yn” that is oppositely disposed immediately below or right above the optional induced voltage generating coil 55 of “Yn”, and the detection coils 14 of “Yn−1” and “Yn+1” disposed to be adjacent thereto. Each of the adjacent detection coils 14 of “Yn−1” and “Yn+1” is the detection coil 14 overlapping, by ⅔, the induced voltage generating coil 55 to which the application pulse P1_Yn is applied. That is, the control unit 10 may further measure induced voltage generated in the detection coils 14 of “Yn−1” and “Yn+1” that are disposed to be opposed and adjacent to the induced voltage generating coil 55 of “Yn” to which the application pulse P1_Yn is applied. Order of measuring the detection coils 14 of “Yn”, “Yn−1”, and “Yn+1” is optional, and can be appropriately changed. This configuration is effective for detecting a phenomenon in which the variation amount d is increased or decreased due to a positional relation between the detection coil 14 and the conductive foreign substance.

For example, in a case of applying an application pulse P1_Y4 to the induced voltage generating coil 55 of “Y4”, induced voltage is generated on the positive side, for example, at the time of falling of the application pulse P1_Y4 in the detection coil 14 of “Y4” right above or immediately below the induced voltage generating coil 55 of “Y4”, or adjacent detection coils 14 of “Y3” and “Y5”. At this point, magnitude of voltage amplitude of the induced voltage satisfies a relation of “Y4”>“Y3”≈“Y5”. That is, in a case of applying the application pulse P1_Yn, a relation of “Yn”>“Yn−1” ˜“Yn+1” is established for the voltage amplitude of the detection pulse R1.

For example, in the detection coils 14 of “Y0” and “Y1”, an induction current in a direction reverse to that in the detection coils 14 of “Y3” to “Y5” is generated, so that induced voltage is generated on the positive side, for example, at the time of rising of the application pulse P1_Y4, and magnitude of voltage amplitude of the induced voltage satisfies a relation of “Y3”≈“Y5”>“Y0”, “Y1”. For example, only fairly small induced voltage is generated in the detection coils 14 of “Y2” and “Y6”.

Due to these facts, that is, when the magnitude of voltage amplitude of the induced voltage satisfies “Y4”>“Y3”≈“Y5”, a case in which the detection pulse R1_R4 of “Y4” reaches a detection upper limit and measurement cannot be performed may be considered. That is, the control unit 10 may be configured to measure the detection pulse R1 for the detection coils 14 of “Yn−1” and “Yn+1” in a case of applying the application pulse P1_Yn to the optional induced voltage generating coil 55 of “Yn” on a regular cycle of the cycle A.

Two or more coils of the induced voltage generating coil 55 may be electrically connected, or may be integrally formed. The electrical connection or integral formation of the induced voltage generating coil 55 may be applied to any one of the induced voltage generating coils 55x and 55y, or may be applied to both directions.

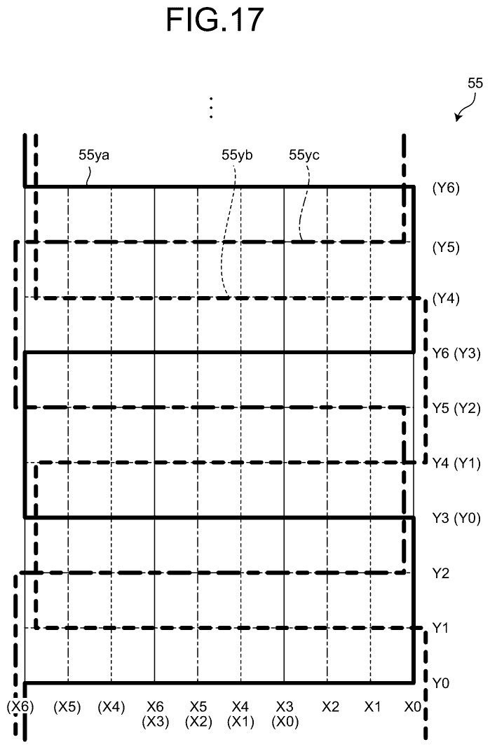

FIG. 17 is a diagram schematically illustrating another example of the configuration of the induced voltage generating coil 55 in FIG. 12. To improve visibility, in FIG. 17, regarding the induced voltage generating coil 55x, coils 55yb and 55yc are depicted to be shifted from a coil 55ya in a right and left direction (X-direction in the drawing). To improve visibility, the induced voltage generating coil 55y is not illustrated. For example, as illustrated in FIG. 17, the coils of the induced voltage generating coil 55 can be disposed as being drawn with a single stroke such that directions of induction currents become the same, the induction currents being generated at adjacent parts of the detection coils 14 adjacent to each other in an upper and lower direction or a left and right direction. In other words, the induced voltage generating coil 55 may have a shape extending over two or more coils of the coils of the detection coil 14 such that the directions of the currents agree between itself and an opposed portion of the coil of the detection coil 14 that is oppositely disposed, or between itself and an opposed portion of the coil disposed to be adjacent to the coil that is oppositely disposed.

By way of example, in the configuration of FIG. 17, the coil 55ya connecting the coil of “Y0” opening toward a right side of a sheet surface, the coil of “Y3” opening toward a left side of the sheet surface, and the coil of “Y6” opening toward the right side of the sheet surface can be used as one coil of the induced voltage generating coil 55y. Similarly, in the configuration of FIG. 12, a coil connecting the coil of “Y2” opening toward the left side of the sheet surface and the coil of “Y5” opening toward the right side of the sheet surface can be used as one coil 55yc of the induced voltage generating coil 55y. Similarly, in the configuration of FIG. 12, the coil 55yb connecting the coil of “Y1” opening toward the left side of the sheet surface and the coil of “Y4” opening toward the right side of the sheet surface can be used as one coil of the induced voltage generating coil 55y. In this case, similarly to a case of using seven coils of “Y0” to “Y6”, the conductive foreign substance on or inside the coil can be detected by three coils including the coil 55ya of “Y0”→“Y3”→“Y6”, the coil 55yc of “Y2”→“Y5”, and the coil 55yb of “Y1”→“Y4”, each of which are drawn with a single stroke.

That is, with the configuration of FIG. 17, each coil of the induced voltage generating coil 55 does not necessarily cover the entire circumference of the detection coil 14 as a single item. Each of the coils 55ya, 55yb, and 55yc generates a transmission pattern for the adjacent detection coil 14 that is not intersecting (overlapping) therewith. That is, with the configuration of FIG. 17, the number of coils of the induced voltage generating coil 55 to be disposed can be reduced, and the number of inputs of a detection signal for induced voltage to the second selection circuit 432 can be reduced. Reduction in the number of inputs of the detection signal for induced voltage, that is, switching of induced voltage generation, contributes to reduction in the number of switches of the switching circuit 434. In the configuration described above, if the conductive foreign substance is present on or inside the coils of “Y0” and “Y4” to “Y6”, induced voltage having voltage amplitude larger than that in a case in which the conductive foreign substance is not present is detected at the time of rising or falling of the pulse signal. Similarly, if the conductive foreign substance is present on or inside the coils of “Y1” to “Y3” of the detection coil 14, induced voltage having voltage amplitude lower than that in a case in which a conductive foreign substance is not present is detected at the time of rising or falling of the pulse signal.

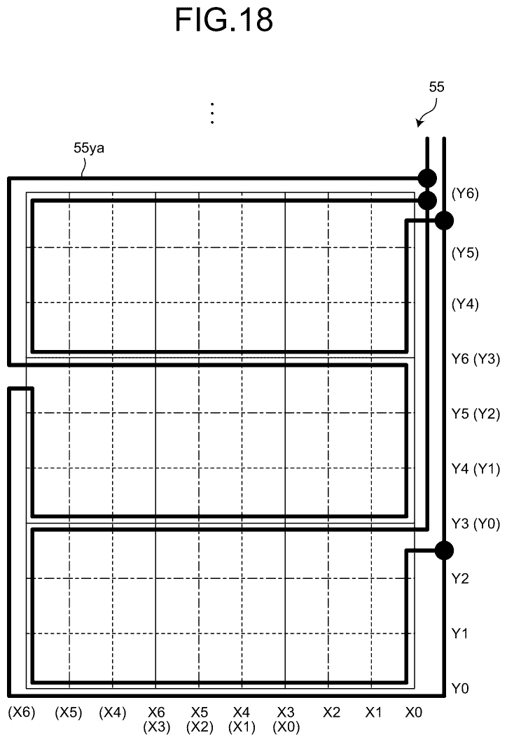

FIG. 18 is a diagram schematically illustrating another example of the configuration of the induced voltage generating coil 55 in FIG. 12. To improve visibility, FIG. 18 exemplifies only the coil 55ya regarding the induced voltage generating coil 55x. To improve visibility, the induced voltage generating coil 55y is not illustrated. As illustrated in FIG. 18, in the configuration of FIG. 12, as the induced voltage generating coil 55, coils that are connected in parallel such that directions of currents agree between each of the coils and a corresponding coil of the detection coil 14 can be used as one coil of the induced voltage generating coil 55y. In this case, as illustrated in FIG. 18, in the coil 55ya, an electric potential at which adjacent portions of the coils of “Y0” and “Y6” and the coil of “Y3” are connected is inverted so that directions of induction currents thereof become the same. Similarly, in the configuration of FIG. 12, a coil connecting the coils of “Y2” and “Y5” in parallel can be used as one coil of the induced voltage generating coil 55y. In this case, an electric potential at which adjacent portions of the coil of “Y2” and the coil of “Y5” are connected is inverted so that directions of induction currents thereof become the same. Similarly, in the configuration of FIG. 12, a coil connecting the coils of “Y1” and “Y4” in parallel can be used as one coil of the induced voltage generating coil 55y. In this case, an electric potential at which adjacent portions of the coil of “Y1” and the coil of “Y4” are connected is inverted so that directions of induction currents thereof become the same. With this configuration, end parts in upper, lower, right, and left directions are expanded for wiring, and it is possible to suppress reduction of coils that can be detected in accordance with connection thereof.

In the configuration of the induced voltage generating coil 55 drawn with a single stroke in FIG. 17, as illustrated in FIG. 14, the number of windings may be increased to two or more. That is, the induced voltage generating coil 55 may be configured to be drawn with a single stroke like as a string. In this case, the connected coils are closed in the upper, lower, left, and right directions on the sheet surface, so that directions of induction currents are reversed between the connected adjacent coils. In other words, the induced voltage generating coil 55 may have a shape extending along at least one of the coils of the detection coil 14 so that the directions of the currents are different from each other between itself and an opposed portion of the coil of the detection coil 14 that is oppositely disposed, or between itself and an opposed portion of the coil disposed to be adjacent to the coil that is oppositely disposed. With this configuration, voltage amplitude of induced voltage can be increased in accordance with increase in the number of windings, and it is possible to suppress reduction of the coils that can be detected in accordance with connection thereof. Additionally, with this configuration, as compared with the configuration in FIG. 12, the number of inputs of the detection signal for induced voltage to the second selection circuit 432 can be reduced, and the number of switches of the switching circuit 434 can be reduced.

The configuration of the induced voltage generating coil 55 with respect to the configuration of the detection coil 14 has been described, but the configurations described above are merely examples, and can be variously changed. The configuration of the induced voltage generating coil 55 with respect to the configuration of the detection coil 14 can be appropriately determined by using, as parameters, a requirement for resolution at a detection position corresponding to the Qi standard or a size of the conductive foreign substance to be detected, and magnetic field intensity corresponding to the number of windings, a wire diameter, and the like of each coil, for example. As described above, the induced voltage generating coil 55 preferably has a configuration corresponding to the configuration of the detection coil 14, but does not necessarily have a configuration corresponding to the configuration of the detection coil 14.

FIG. 19 is a waveform diagram illustrating another example of the application pulse P and the detection pulse R emitted by the foreign substance detection unit 45 in FIG. 9. As illustrated in FIG. 19, a pulse signal (application pulse) applied to the induced voltage generating coil 55 may be successively measured multiple times only on the positive side, for example. A frequency or the number of times (number of pulses) of the pulse signal may be increased, for example, in a case in which the detection coil 14 for measuring a detection pulse moves away from the induced voltage generating coil 55, that is, for the adjacent detection coils 14 of “Yn−1” and “Yn+1”.

In the example of FIG. 19, the control unit 10 applies the application pulse P1_Yn to the optional induced voltage generating coil 55 of “Yn” on a regular cycle of the cycle A, and measures the detection pulse R1_Yn for the detection coil 14 of “Yn” immediately below or right above of the optional induced voltage generating coil 55 of “Yn”. The control unit 10 also applies an application pulse P2_Yn to the induced voltage generating coil 55 of “Yn” on a regular cycle of a cycle B, and measures a detection pulse R2_Yn−1 for the adjacent detection coil 14 of “Yn−1”. The control unit 10 also applies an application pulse P3_Yn to the induced voltage generating coil 55 of “Yn” on a regular cycle of a cycle C, and measures a detection pulse R2_Yn+1 for the adjacent detection coil 14 of “Yn+1”.

With this configuration, for the detection coils 14 other than the detection coil 14 of “Yn” immediately below or right above having small voltage amplitude of induced voltage, measurement accuracy can be improved by multiple times of measurement. The detection coil 14 of “Yn” immediately below or right above is not changed, so that it is possible to suppress increase in EMC noise or power consumption.

As described above, in a case of applying the application pulse P1_Yn to the optional induced voltage generating coil 55 of “Yn”, the induced voltage (detection pulse R1) is generated with voltage amplitude of “Yn”>“Yn−1”≈“Yn+1”. Thus, not only the cycle or the number of times of the application pulse P but also voltage of each application pulse P or an amplification factor of the amplifier 438 for the detection pulse R may be changed. FIG. 20 is a waveform diagram illustrating another example of the application pulse P and the detection pulse R emitted by the foreign substance detection unit 45 in FIG. 9.

For example, in a case of applying the application pulse P1_Yn to the optional induced voltage generating coil 55 of “Yn”, the amplification factor may be “AA” for the detection coil 14 of “Yn”, and the amplification factor may be “AB (>AA)” for the detection coils 14 of “Yn−1” and “Yn+1”. In this case, the application pulse P may be a common voltage value of “VA”.

For example, in a case of applying the application pulse P1_Yn to the optional induced voltage generating coil 55 of “Yn”, the voltage may be “VA” for the detection coil 14 of “Yn”, and the voltage may be “VB (>VA)” for the detection coils 14 of “Yn−1” and “Yn+1”. In this case, the amplification factor of the detection pulse R may be a common amplification factor of “AA”.

With this configuration, in accordance with increase in the amplification factor of the detection pulse R and/or the voltage of the application pulse P, the variation amount d of the voltage amplitude of the induced voltage can be increased as compared with the configuration described above. The number of application pulses P is not increased, so that measurement time for detecting the conductive foreign substance can be shortened. With application to a portion where it is known that the voltage amplitude of the induced voltage to be generated is small, the variation amount d of the voltage amplitude of the induced voltage can be increased.

In measurement of the induced voltage, the control unit 10 compares the variation amount d of the voltage amplitude of the induced voltage obtained by the measurement with a first threshold that is determined in advance and stored in the memory 47, and determines whether the conductive foreign substance is present based on the comparison result. For example, in a case in which a width of a maximum part of the conductive foreign substance is larger than an interval of the detection coil 14 (for example, about 10 mm), and the conductive foreign substance is metal having small resistivity, whether the conductive foreign substance is present can be determined based on the first threshold. In a case of detecting the conductive foreign substance using the first threshold, the control unit 10 stops the measurement from that point on, and causes the alarm 51 to put out an alert. With this configuration, time required for detecting the conductive foreign substance can be shortened.

As the first threshold, a plurality of thresholds may be prepared corresponding to a temperature around the disposition plate 6 as a detection substrate. This is based on the fact that the resistivity of the conductive foreign substance such as metal has a temperature characteristic (temperature dependency). For example, as the temperature of the conductive foreign substance is higher, the resistivity becomes higher, and an eddy current corresponding to magnetic flux from the induced voltage generating coil 55 is difficult to be generated in the conductive foreign substance. Thus, as the first threshold, for example, a smaller value may be set as a measured value of the temperature around the disposition plate 6 obtained by the thermometer 53 is higher.

In a case of detecting the conductive foreign substance using the first threshold, the control unit 10 does not necessarily stop the measurement from that point on but may continue the measurement to determine whether the conductive foreign substance is detected again based on the detection pulse R of the other detection coil 14. With this configuration, detection accuracy for the conductive foreign substance can be improved.

The first threshold is, for example, a threshold of the variation amount d, but may be a threshold of a variation rate. For example, as the first threshold, the threshold of the variation rate can be set such as a range of a change amount equal to or larger than 5% or equal to or smaller than −5%.

For example, there may be a case in which the conductive foreign substance cannot be detected only by determination using the first threshold even if the conductive foreign substance is present such as a case in which the conductive foreign substance is smaller than the interval of the detection coil 14, or a case in which the conductive foreign substance is present on an outermost peripheral part of the detection coil 14.

Thus, the control unit 10 is configured to detect the conductive foreign substance by further using a second threshold to cope with a case in which the variation amount d of the voltage amplitude of the induced voltage is increased or decreased due to a positional relation between the detection coil 14 and the conductive foreign substance, for example.

By way of example, the second threshold is a threshold for determining magnitude of the variation amount d based on measurement results of the detection coils 14. In a case in which the conductive foreign substance is not detected by determination using the first threshold, the control unit 10 determines whether the conductive foreign substance is present using the first threshold for the adjacent detection coil 14 as the second threshold.

By way of example, in a case in which the conductive foreign substance is not detected by determination using the first threshold, the control unit 10 determines whether the conductive foreign substance is present by using, as the second threshold, a value obtained by multiplying the first threshold for the adjacent detection coil 14 by a weighting coefficient.

By way of example, in a case in which the conductive foreign substance is not detected by determination using the first threshold, the control unit 10 determines whether the conductive foreign substance is present using, as the second threshold, a sum of absolute values of the first threshold for the detection coil 14 immediately below or right above and first thresholds for the detection coils 14 on both sides. Alternatively, a value obtained by multiplying the first thresholds of the respective detection coils 14 on both sides by the weighting coefficient may be used.

By way of example, in a case in which the conductive foreign substance is not detected by determination using the first threshold, the control unit 10 determines whether the conductive foreign substance is present using, as the second threshold, a sum of absolute values of the first thresholds for the detection coils 14 on both sides instead of the first threshold for the detection coil 14 immediately below or right above. Alternatively, a value obtained by multiplying the first thresholds of the respective detection coils 14 on both sides by the weighting coefficient may be used. In this case, it is possible to reduce measurement for the detection coil 14 for which the variation amount d is obtained.

With these configurations, even if the position of the conductive foreign substance is the same, reaction of the induced voltage is different at the detection coil 14 at a different relative position, so that the variation amount d in the vicinity of the threshold can be determined.

In the measurement of the induced voltage, the control unit 10 not only detects whether the conductive foreign substance is present but may also detect, in a case in which it is determined that the conductive foreign substance is present, the position thereof. Detection of the position of the conductive foreign substance may be performed irrespective of whether the charging target is present (for example, the terminal device 15).

By way of example, the control unit 10 specifies, as the position of the conductive foreign substance, a position within a range corresponding to the detection coil 14 the variation amount d of which is large in both directions toward an X-side and a Y-side. With this configuration, regarding an alert put out by the alarm 51, for example, an alert including a place of the conductive foreign substance to be removed such as “remove a foreign substance in the vicinity of the center” can be put out, for example.

The control unit 10 may identify the position of the conductive foreign substance based on a sign of the detection pulse R, that is, by using a sum of absolute values as described above.

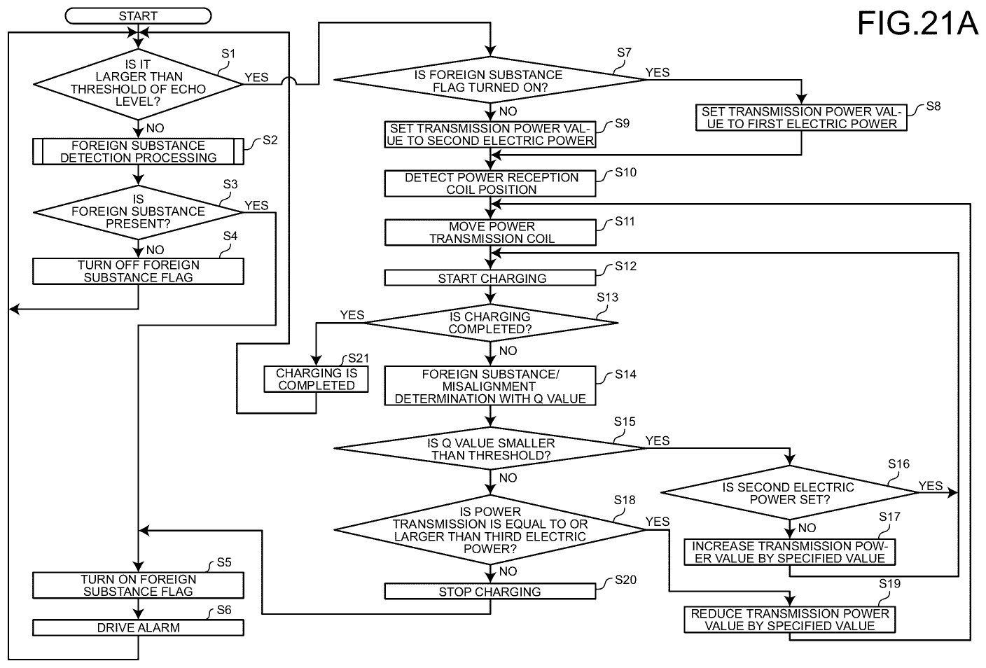

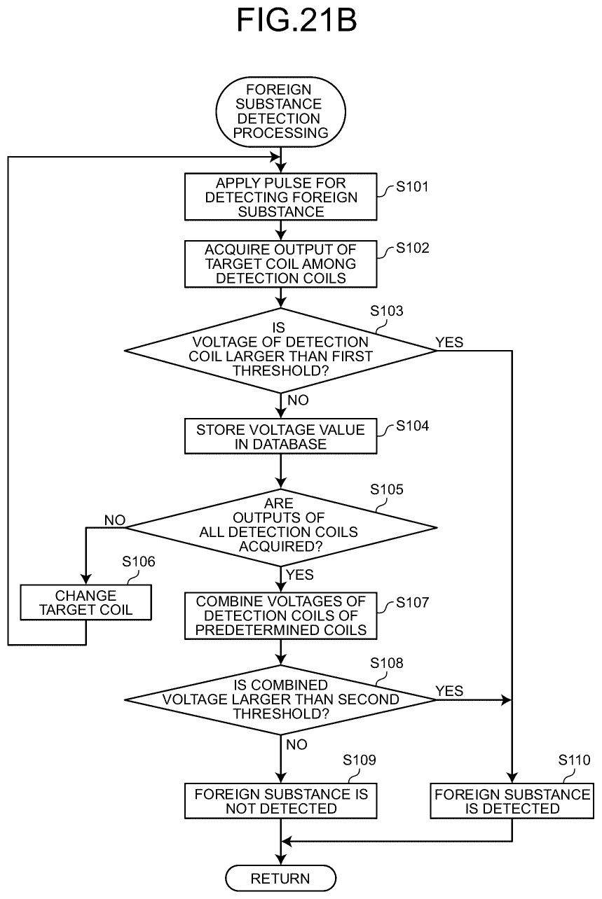

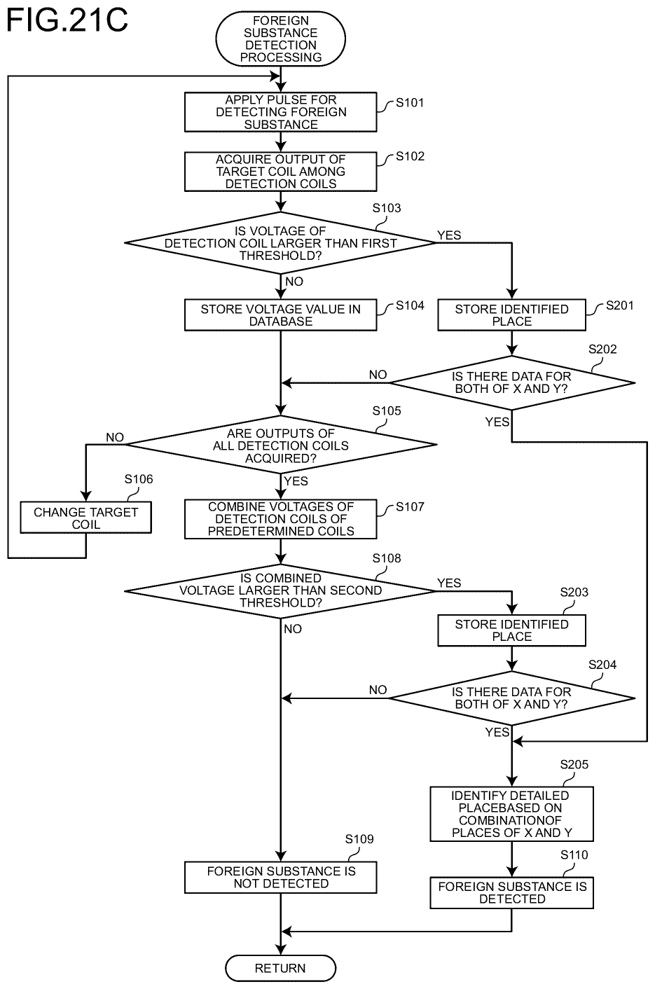

Next, the following describes a procedure of control processing performed by the charging device 5 configured as described above. FIG. 21A is a flowchart illustrating an example of a procedure of control processing performed by the charging device 5 in FIG. 2. The procedure in FIG. 21A is performed after the power source of the charging device 5 is turned on and position initialization of the power transmission coil 8 is performed.

This position initialization means that the control unit 10 drives the motors 28 and 33 via the X-axis motor control unit 36 and the Y-axis motor control unit 37, and returns the power transmission coil 8 to a corner portion illustrated in FIG. 7. For example, in a case of detecting the power transmission coil 8 that has moved to the corner portion in the main body case 7 via switches 41 and 42 disposed at the corner portion, the control unit 10 determines that position initialization of the power transmission coil 8 is performed.

The control unit 10 supplies a signal of 1 MHz to the detection coil 14 via the detection coil control unit 39 at predetermined intervals, and subsequently detects an echo signal. At this point, the control unit 10 temporarily holds the echo signal captured by the detection coil 14 and a time of acquisition (time) in the memory 47. The control unit 10 then determines whether this echo signal is larger than a threshold of an echo level that is determined in advance and stored in the memory 47, for example (S1).

If it is not determined that the echo signal is larger than the threshold of the echo level (No at S1), the control unit 10 performs a foreign substance detection flow (S2 to S6). This foreign substance detection flow is repeatedly performed at predetermined intervals (for example, intervals of 5 minutes) until it is detected that the charging target is placed on the placement surface, for example.

In the foreign substance detection flow, the control unit 10 performs foreign substance detection processing (S2). Herein, a case in which it is not determined that the echo signal is larger than the threshold of the echo level means a case in which the terminal device 15 as a charging target is not placed on the placement surface (upper surface of the disposition plate 6). The foreign substance detection processing will be described later (refer to FIG. 21B or FIG. 21C).

After the foreign substance detection processing, the control unit 10 determines whether the conductive foreign substance is present on the placement surface based on a result of the foreign substance detection processing (S3).

If it is not determined that the conductive foreign substance is present (No at S3), the control unit 10 turns off a foreign substance flag held by the memory 47 (S4). Thereafter, the procedure in FIG. 21A returns to the processing at S1.

If it is determined that the conductive foreign substance is present (Yes at S3), the control unit 10 turns on the foreign substance flag held by the memory 47 (S5). After confirming that the foreign substance flag held by the memory 47 is turned on, the control unit 10 drives the alarm 51 to cause the red light source to blink, emit a warning sound, and present an alert message (S6). Thereafter, the procedure in FIG. 21A returns to the processing at S1.

If it is determined that the echo signal is larger than the threshold of the echo level (Yes at S1), the control unit 10 determines that the terminal device 15 is placed at any position on the upper surface (placement surface) of the disposition plate 6, and performs charging processing (S7 to S20).

In the charging processing, the control unit 10 refers to the foreign substance flag held by the memory 47, and determines whether the foreign substance flag is turned on (S7). If the foreign substance flag is turned on (Yes at S7), the control unit 10 sets a transmission power value transmitted from the power transmission coil 8 to first electric power (S8). On the other hand, if the foreign substance flag is not turned on (No at S7), the control unit 10 sets the transmission power value transmitted from the power transmission coil 8 to second electric power (S9). Herein, the first electric power is a power value smaller than the second electric power, and is a power value for performing, in a case in which the conductive foreign substance is present on the placement surface together with the charging target, wireless charging while suppressing heat generation therefrom.

The control unit 10 causes the detection coil control unit 39 to operate, successively supplies a pulse signal of 1 MHz to the detection coils 14x and 14y, and identifies a position of the power reception coil 15a of the terminal device 15 on the placement surface (S10). The control unit 10 drives the motors 28 and 33 via the X-axis motor control unit 36 and/or the Y-axis motor control unit 37, and moves the power transmission coil 8 to the position of the detected power reception coil 15a of the terminal device 15 (S11). Thereafter, the control unit 10 starts to perform wireless charging for the terminal device 15 by the power transmission coil 8 via the power transmission coil control unit 38 (S12).

Thereafter, the control unit 10 determines whether the charging is completed (S13). If charging is not completed (No at S13), the control unit 10 performs foreign substance/misalignment determination with the Q value (S14). The foreign substance/misalignment determination with the Q value is processing for detecting the conductive foreign substance, and misalignment of relative positions of the power reception coil 15a of the terminal device 15 being charged and the power transmission coil 8 based on the Q value. After the foreign substance/misalignment determination with the Q value, the control unit 10 determines whether the Q value is smaller than a threshold of the Q value determined in advance (S15).

If the Q value is smaller than the threshold of the Q value determined in advance (Yes at S15), the control unit 10 determines whether the transmission power value is set to the second electric power (S16). If the transmission power value is set to the second electric power (Yes at S16), the procedure in FIG. 21A returns to the processing at S12, and charging is continued. On the other hand, if the transmission power value is not set to the second electric power (No at S16), the control unit 10 increases the transmission power value by a specified value (S17). For example, the control unit 10 increases the transmission power value to a second power value. Thereafter, the procedure in FIG. 21A returns to the processing at S12, and the charging is continued.

If the Q value is equal to or larger than the threshold of the Q value determined in advance (No at S15), the control unit 10 determines whether the transmission power value at the present time is equal to or larger than third electric power (S18). Herein, the third electric power is a power value larger than the second electric power, and determined in advance and stored in the memory 47, for example.

If electric power equal to or larger than the third electric power is transmitted (Yes at S18), the control unit 10 reduces the transmission power value by a specified value (S19). For example, the control unit 10 reduces the transmission power value to the second power value. Thereafter, the procedure in FIG. 21A returns to the processing at S11, and the charging is continued after moving the power transmission coil 8. Due to this, even in a case in which there is no conductive foreign substance, charging efficiency is lowered due to misalignment, and the transmission power value is increased, for example, the charging efficiency before misalignment is caused can be maintained by moving the power transmission coil 8 to an appropriate position.

If electric power equal to or larger than the third electric power is not transmitted (No at S18), the control unit 10 stops charging (S20). Herein, a case in which the Q value is equal to or larger than the threshold of the Q value determined in advance and electric power equal to or larger than the third electric power is not transmitted is a case in which the conductive foreign substance is detected based on the Q value. Thereafter, the procedure in FIG. 21A proceeds to the processing at S5, the foreign substance flag is turned on (S5), and the alarm 51 is driven (S6). Due to this, the conductive foreign substance can be detected based on the Q value even after the charging is started.

If the charging is completed (Yes at S13), the procedure in FIG. 21A ends.

The following describes the foreign substance detection processing with reference to the drawings.

First, the following describes the foreign substance detection processing without performing position detection of the conductive foreign substance. FIG. 21B is a flowchart illustrating an example of a procedure of the foreign substance detection processing in the control processing in FIG. 21A.

The control unit 10 applies the pulse signal (application pulse P) for detecting a foreign substance to the induced voltage generating coil 55 via the induced voltage generating coil control unit 46 (S101), and acquires the voltage amplitude (detection pulse R) of the induced voltage measured by the target detection coil 14 (S102). The control unit 10 determines whether the variation amount d of the measured detection pulse R is larger than the first threshold (S103).

If the variation amount d of the measured detection pulse R is equal to or smaller than the first threshold (No at S103), the control unit 10 stores the measured variation amount d (voltage value) in a database in the memory 47 (S104). Thereafter, the control unit 10 determines whether outputs of the detection coils 14 are acquired for all combinations of the induced voltage generating coils 55 and the detection coils 14 as measurement targets (S105). If outputs of all of the detection coils 14 are not acquired (No at S105), the control unit changes a target from which an output is acquired, that is, the detection coil 14 as a measurement target (S106). Thereafter, the procedure in FIG. 21B returns to the processing at S101.

If outputs of all of the detection coils 14 are acquired (Yes at S105), the control unit 10 combines variation amounts d measured for combinations determined in advance (S107). The control unit 10 then determines whether the combined voltage is larger than the second threshold (S108).

If the combined voltage is equal to or smaller than the second threshold (No at S108), the control unit 10 determines that the conductive foreign substance is not detected (S109). On the other hand, if the variation amount d of the measured detection pulse R is larger than the first threshold (Yes at S103), or if the combined voltage is larger than the second threshold (Yes at S108), the control unit 10 determines that the conductive foreign substance is detected (S110). Thereafter, the procedure in FIG. 21B ends, and the process returns to the procedure in FIG. 21A.

Next, the following describes the foreign substance detection processing in a case of also performing position detection of the conductive foreign substance. FIG. 21C is a flowchart illustrating another example of the procedure of the foreign substance detection processing in the control processing in FIG. 21A. Herein, differences from FIG. 21B are mainly described, and redundant description is appropriately omitted.

If the variation amount d of the measured detection pulse R is larger than the first threshold (Yes at S103), the control unit 10 identifies, as the position of the conductive foreign substance, a place of the detection coil 14 where the variation amount d of the measured detection pulse R is larger than the first threshold, and temporarily stores this place in the memory 47 (S201). Thereafter, the control unit 10 determines whether measurement results of both of the detection coils 14x and 14y are obtained, that is, whether the position of the conductive foreign substance is identified based on the first threshold in both of the X-direction and the Y-direction (S202).

If the position of the conductive foreign substance in any of the X-direction and the Y-direction is not identified based on the first threshold (No at S202), the procedure in FIG. 21C proceeds to the processing at S105.

If the position of the conductive foreign substance in both of the X-direction and the Y-direction is identified based on the first threshold (Yes at S202), the procedure in FIG. 21C proceeds to the processing at S205.

If the combined voltage is larger than the second threshold (Yes at S108), the control unit 10 temporarily stores, in the memory 47, the position of the conductive foreign substance identified based on the second threshold (S203). Thereafter, the control unit 10 determines whether the position of the conductive foreign substance in both of the X-direction and the Y-direction is identified based on the second threshold (S204).

If the position of the conductive foreign substance in any of the X-direction and the Y-direction is not specified based on the second threshold (No at S204), the procedure in FIG. 21C proceeds to the processing at S109.

If the position of the conductive foreign substance in both of the X-direction and the Y-direction is identified based on the second threshold (Yes at S204), the procedure in FIG. 21C proceeds to the processing at S205.

If the position of the conductive foreign substance in both of the X-direction and the Y-direction is identified based on the first threshold or the second threshold (Yes at S202 and S204), the control unit 10 identifies a detailed place of the conductive foreign substance that is detected based on a combination of places in the X-direction and the Y-direction (S205). The control unit 10 temporarily stores the identified detailed place of the conductive foreign substance in the memory 47. Thereafter, the procedure in FIG. 21C proceeds to the processing at S110.

As described above, in the charging device 5 according to the embodiment, the control unit 10 is configured to supply electric power to the coil of the induced voltage generating coil 55 in a state in which the terminal device 15 is not placed on the placement surface, and to determine that the conductive foreign substance is present on the placement surface in a case in which the variation amount d of the induced voltage generated in the detection coil 14 in accordance with the magnetic field generated from the coil is equal to or larger than the predetermined threshold.

With this configuration, in a state in which the terminal device 15 is not placed on the placement surface, presence/absence and/or a position of the conductive foreign substance on the placement surface can be detected. In a case in which the conductive foreign substance is detected, the alarm 51 can make a notification to the user, and prompt the user to remove the foreign substance. Thus, with the configuration described above, usability of wireless charging can be improved.

### Second Embodiment

The following describes another aspect of the charging device 5 according to the present disclosure. Herein, differences from the charging device 5 according to the first embodiment are mainly described, and redundant description is appropriately omitted.

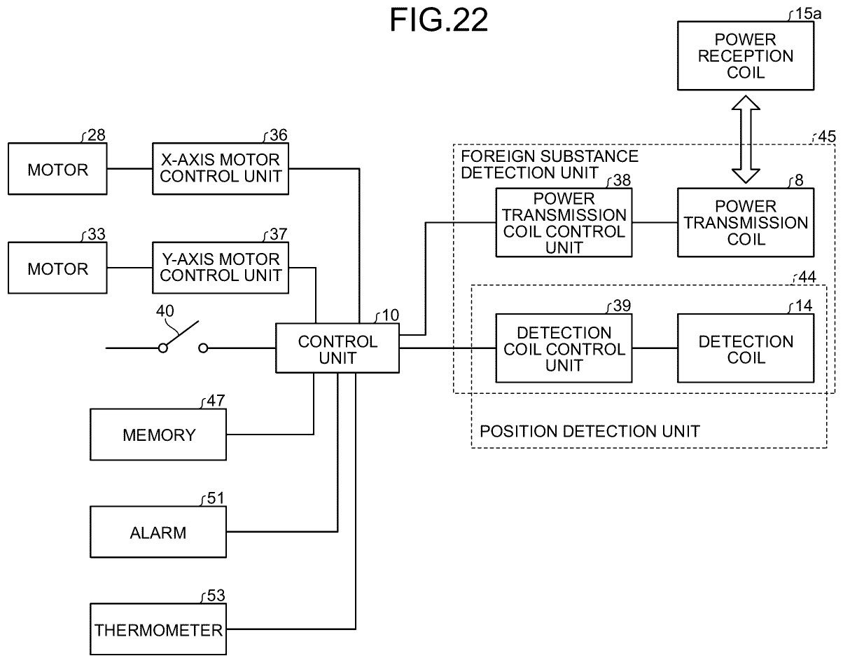

FIG. 22 is a control block diagram illustrating an example of the configuration of the charging device 5 according to the second embodiment. The charging device 5 according to the second embodiment is the same as the charging device 5 according to the first embodiment except that the induced voltage generating coil control unit 46 and the induced voltage generating coil 55 are not disposed.

In the charging device 5 according to the second embodiment, the position detection unit 44 includes the detection coil 14 and the detection coil control unit 39 similarly to the charging device 5 according to the first embodiment.

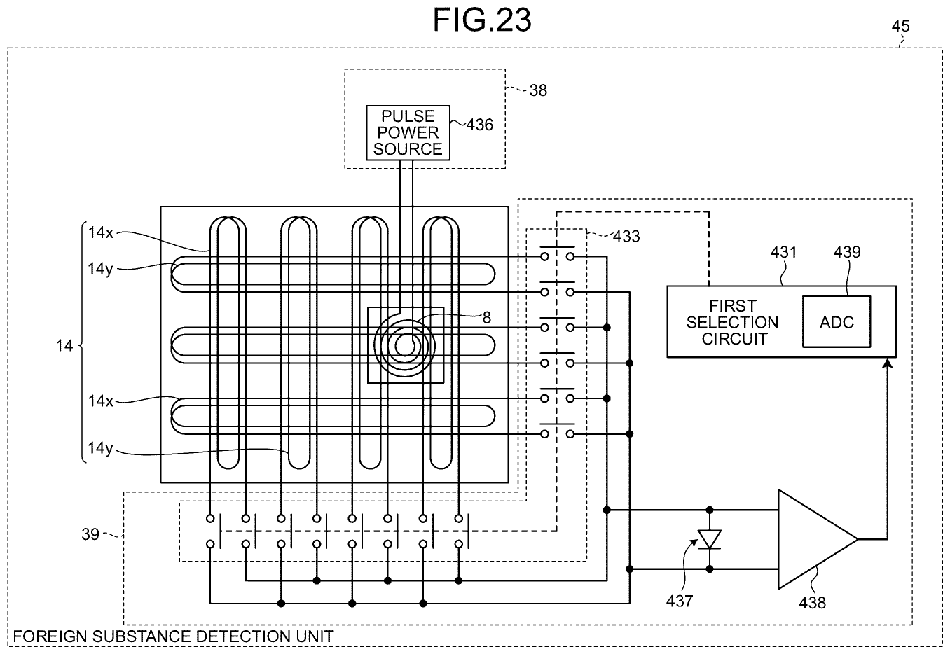

FIG. 23 is a control block diagram illustrating an example of the configuration of the foreign substance detection unit 45 in FIG. 22. In the charging device 5 according to the second embodiment, the foreign substance detection unit 45 includes the power transmission coil 8, the detection coil 14, the power transmission coil control unit 38, and the detection coil control unit 39 unlike the charging device 5 according to the first embodiment.

In the charging device 5 according to the second embodiment, the detection coil 14 and the detection coil control unit 39 of the foreign substance detection unit 45 are the same as those in the charging device 5 according to the first embodiment, so that the description thereof will not be repeated.

In the charging device 5 according to the second embodiment, the pulse power source 436 of the foreign substance detection unit 45 is disposed in the power transmission coil control unit 38. In other words, the power transmission coil 8 according to the second embodiment is a coil that generates induced voltage for causing the detection coil 14 to detect presence or a position of the conductive foreign substance on the placement surface similarly to the induced voltage generating coil 55 according to the first embodiment. The pair of output nodes of the pulse power source 436 are electrically connected to a pair of input nodes of the power transmission coil 8 via a switch (not illustrated). The pulse power source 436 generates a pulse signal at a predetermined timing, and supplies the generated pulse signal to the connected power transmission coil 8. The pulse power source 436 is electrically connected to a power source (not illustrated). This power source may be an external power source disposed outside the charging device 5 such as a vehicle-mounted battery or a commercial power source, or may be a battery (not illustrated) mounted on the charging device 5. The pulse power source 436 may be configured integrally with the power source.

In the charging device 5 according to the second embodiment, the power transmission coil control unit 38 moves the power transmission coil 8 to a position corresponding to the detection coil 14 as a measurement target, and applies the pulse signal from the pulse power source 436 to the power transmission coil 8 to generate an induction current in the detection coil 14 in the vicinity of the power transmission coil 8.

In the charging device 5 according to the second embodiment, the first selection circuit 431 controls the switching circuit 433 so that the detection coil 14 corresponding to the position of the power transmission coil 8 is connected to the amplifier 438. The switching circuit 433 switches the detection coil 14 to be connected to the amplifier 438 in accordance with a control signal from the first selection circuit 431.

In the charging device 5 according to the second embodiment, the memory 47 stores, for example, a value of induced voltage of the detection coil 14 (for example, a peak value thereof) that is measured in advance in a state in which the conductive foreign substance is not present. This value of the induced voltage is a value that is measured for each of a plurality of positions in a moving range of the power transmission coil 8 by disposing the power transmission coil 8 at each position in a state in which the conductive foreign substance is not present. The position of the power transmission coil 8 varies every time the charging device 5 uses it. Thus, a plurality of places determined in advance may be set as end positions thereof. For example, sound is generated when the power transmission coil 8 is moved, so that the charging device 5 may be configured to be turned off after moving the power transmission coil 8 to a position closest to a place determined in advance.

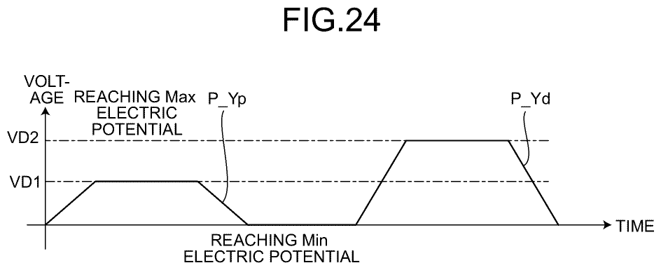

FIG. 24 is a waveform diagram illustrating an example of the application pulse P and the detection pulse R emitted by the foreign substance detection unit 45 in FIG. 22. In the measurement of the induced voltage, the control unit 10 applies the pulse signal (application pulse P) to the power transmission coil 8 from the power transmission coil control unit 38.

At this point, orientation of the magnetic field passing through each coil of the detection coil 14 varies depending on whether there is an overlap between the cavity part at the center part of the power transmission coil 8 and each coil of the detection coil 14. Thus, the induced voltage appearing on the positive side of each detection coil 14 appears either at the time of rising or at the time of falling of the pulse applied to the power transmission coil 8 in accordance with the orientation of the magnetic field through which it passes, that is, in accordance with whether an overlap with the power transmission coil 8 is present.

For example, in a case in which the cavity part of the power transmission coil 8 is positioned immediately below or right above the optional detection coil 14 of “Yn”, magnitude of the voltage amplitude (detection pulse R) of the induced voltage generated in the detection coil 14 has a relation of “Yn”>“Yn−1” ˜“Yn+1”. Thus, similarly to the charging device 5 according to the first embodiment, amplification factors of “Yn”, “Yn−1”, and “Yn+1”, or a voltage value of the application pulse P may be changed without changing the cycle or the number of times.

For example, a driving voltage P_Y of the power transmission coil 8, that is, “(reaching Max electric potential)−(reaching Min electric potential)”, may be larger than a “driving voltage of the detection coil 14”. In this case, the variation amount d of the induced voltage can be confirmed without moving the power transmission coil 8.

For example, a supply voltage (driving voltage P_Y) to the power transmission coil 8 may be an application pulse P_Yp at a voltage of “VD1” in a case of acquiring an output of the detection coil 14 in the vicinity of the power transmission coil 8, and may be an application pulse P_Yd at a voltage of “VD2 (>VD1)” in a case of acquiring an output of the detection coil 14 distant from the power transmission coil 8. Herein, the detection coil 14 in the vicinity of the power transmission coil 8 is the detection coil 14 having an overlap with the cavity part of the power transmission coil 8. Similarly, the detection coil 14 distant from the power transmission coil 8 is the detection coil 14 not having an overlap with the cavity part of the power transmission coil 8.

The control unit 10 acquires, by the detection coil control unit 39, the voltage amplitude (detection pulse R) of the induced voltage generated in the detection coil 14 in accordance with the magnetic field generated by the power transmission coil 8. FIG. 24 exemplifies measurement of the induced voltage in accordance with the Y-direction similarly to FIG. 16, but the same applies to measurement of the induced voltage in accordance with the X-direction.

In the charging device 5 according to the second embodiment, measurement time is increased due to movement of the power transmission coil 8 (moving coil). On the other hand, by causing the peak value of the application pulse P to be larger than the application pulse P according to the first embodiment (for example, 1.5 times or more), the charging device 5 according to the second embodiment can reduce a risk such that the conductive foreign substance is not detected in determination by using the first threshold even when the conductive foreign substance is present, such as a case in which the conductive foreign substance is present on an outermost peripheral part of the detection coil 14.

The charging device 5 according to the second embodiment may detect not only whether the conductive foreign substance is present but also the position thereof similarly to the charging device 5 according to the first embodiment.

As described above, in the charging device 5 according to the embodiment, the control unit 10 is configured to supply electric power to the power transmission coil 8 in a state in which the terminal device 15 is not placed on the placement surface, and to determine that the conductive foreign substance is present on the placement surface in a case in which the variation amount d of the induced voltage generated in the detection coil 14 in accordance with the magnetic field generated from the power transmission coil 8 is equal to or larger than the predetermined threshold.

Even with this configuration, the same effect as that in the first embodiment can be obtained. Additionally, necessity for the induced voltage generating coil 55 and the induced voltage generating coil control unit 46 can be eliminated, so that the charging device 5 can be downsized and cost therefor can be reduced.

### Third Embodiment

The following describes another aspect of the charging device 5 according to the present disclosure. Herein, differences from the charging device 5 according to the first embodiment are mainly described, and redundant description is appropriately omitted.

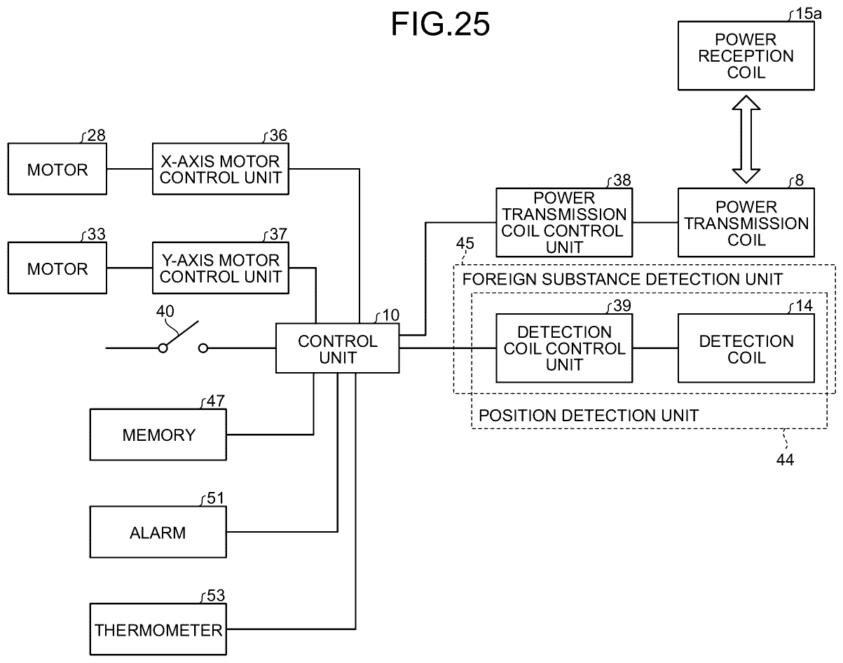

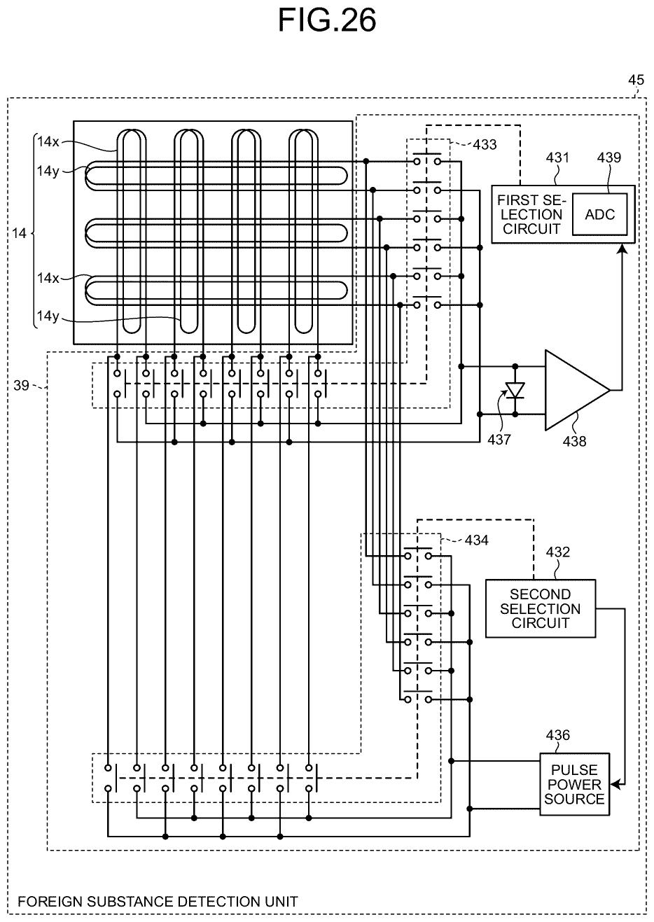

FIG. 25 is a control block diagram illustrating an example of the configuration of the charging device 5 according to a third embodiment. FIG. 26 is a control block diagram illustrating an example of the configuration of the foreign substance detection unit 45 in FIG. 25.

In the charging device 5 according to the third embodiment, the position detection unit 44 includes the detection coil 14 and the detection coil control unit 39 similarly to the charging device 5 according to the first embodiment.

In the charging device 5 according to the third embodiment, the foreign substance detection unit 45 includes the detection coil 14 and the detection coil control unit 39 unlike the charging device 5 according to the first embodiment.

In the charging device 5 according to the third embodiment, the induced voltage generating coil control unit 46 and the induced voltage generating coil 55 are not disposed. On the other hand, in the charging device 5 according to the third embodiment, the second selection circuit 432, the switching circuit 434, and the pulse power source 436 are further disposed in the detection coil control unit 39.

In the charging device 5 according to the third embodiment, the pulse power source 436 of the foreign substance detection unit 45 is electrically connected to the detection coil 14 via the switching circuit 434. In other words, the detection coil 14 according to the third embodiment is electrically connected to the amplifier 438 via the switching circuit 433, and electrically connected to the pulse power source 436 via the switching circuit 434.

In the charging device 5 according to the third embodiment, the second selection circuit 432 of the detection coil control unit 39 applies the pulse signal from the pulse power source 436 to the detection coil 14 as a target to generate an induction current in the detection coil 14. In the charging device 5 according to the third embodiment, the first selection circuit 431 of the detection coil control unit 39 determines that the conductive foreign substance is close to the detection coil 14 based on variation in the induced voltage (difference in the voltage amplitude) caused by the induction current generated in the other detection coil 14 that is adjacent to and/or oppositely intersects with the detection coil 14 to which the pulse signal is applied.

For example, in a case of applying the application pulse P to the optional detection coil 14y of “Yn”, generated induced voltage may be measured for each of the detection coils 14 including the detection coil 14y of “Yn+3” disposed to be adjacent to the detection coil 14y of “Yn” and all of the detection coils 14x of “Xn” (n=0 to 6) disposed to oppositely intersect with the detection coil 14y of “Yn”.

The induced voltage generated at an oppositely intersecting portion is smaller than that generated at an adjacent disposition portion on the same surface. Thus, the induced voltage generated in the oppositely intersecting part, that is, in the detection coil 14 that is oppositely disposed in an intersecting manner, may be caused to be a measurement target for an area that cannot be measured with the detection coils 14 disposed to be adjacent to each other (for example, coils at four corners of the detection coil 14).

Similarly to the charging device 5 according to the first embodiment, in detecting the conductive foreign substance by further using the second threshold, the charging device 5 according to the third embodiment may identify a position where the variation amount d is large, do not apply the application pulse to the detection coil 14 at this position, and move the position of the power transmission coil 8 at least three points within the oppositely intersecting part. With this configuration, the variation amount d is reduced when the cavity part of the power transmission coil 8 overlaps the conductive foreign substance, so that presence and/or a position of the conductive foreign substance can be detected based on the reduction in the variation amount d. This configuration is effective in a case in which the variation equal to or larger than 50% of the threshold is caused while the threshold is not exceeded, for example.

As described above, in the charging device 5 according to the embodiment, the control unit 10 is configured to supply electric power to a first coil among the coils of the detection coil 14 in a state in which the terminal device 15 is not placed on the placement surface, and to determine that the conductive foreign substance is present on the placement surface in a case in which the variation amount of the induced voltage generated in a second coil in accordance with a magnetic field generated from the first coil is equal to or larger than the predetermined threshold, the second coil being different from the first coil and disposed to oppositely intersect with or disposed to be adjacent to the first coil among the coils of the detection coil 14.

Even with this configuration, the same effect as that in the first embodiment can be obtained. Additionally, necessity for moving the power transmission coil 8 is eliminated in measurement of the induced voltage, so that time required for the foreign substance detection processing can be reduced.

The technique according to the third embodiment can also be applied to the charging device 5 according to the second embodiment in place of or in addition to the charging device 5 according to the first embodiment.

A computer program executed by the charging device 5 in each of the embodiments described above is recorded and provided in a computer-readable recording medium such as a CD-ROM, an FD, a CD-R, and a DVD, as an installable or executable file.

The computer program executed by the charging device 5 in each of the embodiments described above may be stored in a computer connected to a network such as the Internet and provided by being downloaded via the network. The computer program executed by the charging device 5 in each of the embodiments described above may be provided or distributed via a network such as the Internet.

The computer program executed by the charging device 5 in each of the embodiments described above may be embedded and provided in a ROM, for example.

According to at least one of the embodiments described above, the conductive foreign substance on the placement surface can be detected before the charging target of wireless charging is placed on the placement surface.

According to the present disclosure, it is possible to detect the conductive foreign substance on the placement surface before the charging target of wireless charging is placed on the placement surface.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A charging device configured to perform wireless charging for a terminal device that is placed on a placement part and includes a power reception coil for receiving wirelessly transmitted electric power, the charging device comprising:
a power transmission coil for charging configured to transmit electric power to the terminal device;
a position detection coil that includes a plurality of coils, and is configured to detect a position of the power reception coil of the terminal device;
a foreign substance detection coil that includes a plurality of coils corresponding to the plurality of coils of the position detection coil, and is configured to detect a conductive foreign substance on the placement part;
a memory; and
a processor coupled to the memory and configured to supply electric power to a first coil among the plurality of coils of the foreign substance detection coil in a state in which the terminal device is not placed on the placement part, to determine that the conductive foreign substance is present on the placement part in a case in which a variation amount of induced voltage generated in the position detection coil in accordance with a magnetic field generated from the first coil is equal to or larger than a predetermined threshold.

2. The charging device according to claim 1, wherein the processor is configured to determine whether the conductive foreign substance is present based on a variation amount of the induced voltage generated in at least one of an oppositely disposed coil disposed opposite to the first coil of the foreign substance detection coil, and an adjacently disposed coil disposed adjacent to the oppositely disposed coil, among the plurality of coils of the position detection coil.

3. The charging device according to claim 2, wherein the first coil of the foreign substance detection coil extends over two or more of the plurality of coils of the position detection coil such that directions of currents agree between the first coil and an opposed portion of the oppositely disposed coil of the position detection coil and between the first coil and an opposed portion of the adjacently disposed coil of the position detection coil.

4. The charging device according to claim 2, wherein the first coil of the foreign substance detection coil extends along at least one of the plurality of coils of the position detection coil such that directions of currents are different between the first coil and an opposed portion of the oppositely disposed coil of the position detection coil and between the first coil and an opposed portion of the adjacently disposed coil of the position detection coil.

5. The charging device according to claim 2, wherein the first coil of the foreign substance detection coil includes two or more coils connected in parallel with each other such that directions of currents agree between the first coil and an opposed portion of the oppositely disposed coil of the position detection coil and between the first coil and an opposed portion of the adjacently disposed coil of the position detection coil.

6. A charging device configured to perform wireless charging for a terminal device that is placed on a placement part and includes a power reception coil for receiving wirelessly transmitted electric power, the charging device comprising:
a power transmission coil for charging configured to transmit electric power to the terminal device;
a driver configured to move the power transmission coil;
a position detection coil that includes a plurality of coils, and is configured to detect a position of the power reception coil of the terminal device;
a memory; and
a processor coupled to the memory and configured to supply electric power to the power transmission coil in a state in which the terminal device is not placed on the placement part, to determine that a conductive foreign substance is present on the placement part in a case in which a variation amount of induced voltage generated in the position detection coil in accordance with a magnetic field generated from the power transmission coil is equal to or larger than a predetermined threshold.

7. The charging device according to claim 6, wherein
the power transmission coil is a coil formed in a circular ring shape, and
the processor is configured to determine whether the conductive foreign substance is present based on a variation amount of the induced voltage generated in at least one of an oppositely disposed coil disposed opposite to a cavity part at a center part of the circular ring shape of the power transmission coil and a coil disposed adjacent to the oppositely disposed coil, among the plurality of coils of the position detection coil.

8. A charging device configured to perform wireless charging for a terminal device that is placed on a placement part and includes a power reception coil for receiving wirelessly transmitted electric power, the charging device comprising:
a power transmission coil for charging configured to transmit electric power to the terminal device;
a position detection coil that includes a plurality of coils, and is configured to detect a position of the power reception coil of the terminal device;
a memory; and
a processor coupled to the memory and configured to supply electric power to a first coil among the plurality of coils of the position detection coil in a state in which the terminal device is not placed on the placement part, to determine that a conductive foreign substance is present on the placement part in a case in which a variation amount of induced voltage generated in a second coil different from the first coil among the plurality of coils of the position detection coil in accordance with a magnetic field generated from the first coil is equal to or larger than a predetermined threshold.

9. The charging device according to claim 8, wherein the second coil is a coil disposed opposite to and intersect with the first coil or a coil disposed adjacent to the first coil among the plurality of coils of the position detection coil.
